(19) United States
(12) Patent Application Publication
(10) Pub. No.: US 2009/0072545 A1
(43) Pub. Date: Mar. 19, 2009

(54) Process of processes for radical solution of the air pollution and the global warming, based on the discovery of the bezentropic thermomechanics and eco fuels through bezentropic electricity

(76) Inventor: Christopher Van Michaels, Sofia (BG)

Correspondence Address: Van Michaels C ., Apt. 17, Bulevard 'Patriarch Evtimiy N36,-b , ent. II, Sofia, 1000, BG

(21) Appl. No.: 12/214,840

(22) Filed: Jun. 24, 2008

Related U.S. Application Data
(63) Continuation-in-part of application No. 10/620,870, filed on Jul. 15, 2003, now abandoned.
Application No. 10/620,870 is a continuation-in-part of application No. 05/735,110, now Pat. No. 4,107,282.
Application No. 05/735,110 is a continuation-in-part of application No. 06/156,563, filed on Jun. 5, 1980, now Pat. No. 4,519,206.

(51) Int. Cl. F03G 7/00; F03G 7/10

(52) U.S. Cl. 290/1 A; 415/916

(57) ABSTRACT

This high tech invention stems from the recent discovery of a new natural thermal law and its numerous applications, named for short ‘universal law of bezentropy’. Its full name is; ‘Law of the bezentropic spontaneous natural and artificial rectification of the disorderly vibrating gas and steam molecules into colinear ordered molecular jets, creating a valuable new science termed ‘bezentropic thermomechanics’ permitting (practically) full conversion of the heat into work, which is otherwise prohibited by the law of ‘entropy”, a.k.a, the second law of thermodynamics. The precursors of this important discovery are found in the startling paradoxes nos: 1, 2, and 3, included within this disclosure, and discovered as well by this inventor. They help in better understanding the law of bezentropy.

This high tech invention reveals the theory and the applications of a new engineering science termed BEZENTROPIC THERMOMECHANICS. It is continuation in part of my previous U.S. patent application Ser. No. 10/620,870 Filed on Aug. 15-2003 Titled: CLEAN PROCESS OF PROCESSES FOR MANUFACTURING NON CANCEROGENOUS ZERO POLLUTING ECO FUELS FROM GAS HYDRATES, NOT EXHAUSTING EVEN CO₂, TO FACE THE CANCER AND THE MENACING GREEN HOUSING EFFECT—now abandoned, due to mysterious, TWICE NOT DELIVERED to the Applicant the examiner's papers—precluding the Patent Applicant to answer them. The present invention is continuation in part also of applicant's issued USA Patents: U.S. Pat. No. 4,107,282, issued on Aug. 15-1978, titled ACETILIDE CATALYST and PROCESS FOR PRODUCING HYDROGEN; the U.S. Pat. No. 4,110,082, from Aug. 29-1978, Titled REFORMED HYDROCARBONS AND ALCOHOLS FROM FUEL ALLOYS AND REFORMING AGENTS and the U.S. Pat. No. 4,519,206 issued on May 28-1985, titled MULTY—FUELS ROTARY POWER PLANT, USING GAS PISTONS, ELLIPTIC COMPRESSORS, INTERNALLY COOLED THERMODYNAMIC CYCLES AND SLURRY TYPE COLLOIDAL FUEL FROM COAL AND CHARCOAL.

### THE MAIN GOAL OF THE INVENTION AND ITS SPECIFIC OBJECTS AND PROCESSES

The main goal of this invention is zero air pollution worldwide and stopping the global warming. This requires a series of novel, inexpensive and zero polluting fuels, hydrogen, electricity, and engines of higher efficiency plus less expensive new primary sources of energy from which to derive eco fuels and electricity. Needed are also more efficient new chemical and electrochemical reactions and processes to guarantee clean combustion, manufacturing and more efficient heat to other energies conversions. Needed for transition are also startling new engine and turbines allowing (practically) full conversion of the heat into work and electricity, which cannot be attained by the current state of the engine technology based on the classic thermodynamics—relying entirely on the helpless classic LAW of the ENTROPY. This classic law created a worst scientific prejudice against any effort to go beyond the frontiers of the thermodynamics, where actually resides the much more powerful LAW OF THE BEZENTROPY, which created the new engineering and scientific discipline of the BEZENTROPIC THERMOMECHANICS. Namely this way this inventor engineered the herein disclosed MORE EFFICIENT BEZENTROPIC TURBINES, ENGINES, COMPRESSORS AND POWER PLANTS.

The inventor—one old professor physicist and industrial chemist—found that, to really attain the goal of this invention, must abandon all contemporary fuels, engines, turbines, power plants and expensive electricity, and replace them by new such items and processes that must allow to produce inexpensive electricity and zero polluting hydrogen, other fuels and agricultural and transportation vehicles. Said new processes must give to the people:

(1) a special designed ‘safety hydrogen’, getting rid of its explosivity, capable of replacing the Gasoline, the Methane, as well as all other hydrocarbons and to invent

(2) new engines and turbine, of supreme efficiency and zero pollution for use in all applications, allowing to use either: hydrogen, methane, the ‘acetal fuel’s of this invention, and when they are not available, to switch back to gasoline and Diezel fuel, just by pushing a button, thus, convincing people to easier abandon the inefficient and polluting classic heat engines and turbines; convincing also the investors to turn to the Bezentropic thermomechanics and processes; thus, to promote the new generations of non polluting and energy saving bezentropic engines, turbines and power plants. When powering them by safety hydrogen fuel, that would bring to our civilization the crystal clear air of the biblical times.

Evidently, such radical tasks cannot be attained by a single process. Hence, the inventor herein discloses a Process, of intrinsically connected series of processes, permitting to attain the difficult main goal of the invention, where each of series' particular problem represents a particular object of the invention. In that respect the MAIN OBJECT of the MAIN GOAL of the invention is the new way for deriving of inexpensive safety hydrogen done by a plurality of two chemical and one electrochemical processes. The first of them is a low temperature REDOX PROCESS conducted in the absence of air. The second one is a modified process of my previously patented ‘Fuel alloys process’; and the third one represents electrolysis of large volumes of water through inexpensive electricity derived from a special BEZENTROPIC POWER PLANT.

Another object of the invention is the conversion of the highly explosive hydrogen into ‘quiet hydrogen’ allowing it to be safely piped for home and for industrial users. The inventor borrowed the quieting method from Mother Nature—quieting the dangerous oxygen by blending it with 4 parts nitrogen; thereby obtaining the safe Air.

In the case of the hydrogen, the inventor did the same and in the mean time discovered that one may create different grades of ‘safety hydrogen’ by blending 10% to 40% hydrogen into by-produced nitrogen, from the chimney of the Bezentropic Power Plant.

A third object—concerning the intermediary process of clean engine fuels—is the conversion of: the Methane, the hydrocarbons from inventor's fuel alloys and the Methane hydrates into the superior Acetal fuels of this invention. Related to that a supplemental original process for prospecting and mining the deep see Methane hydrates was discovered.

A detailed analysis of the global warming and air pollution problems showed to the inventor that: what is most wrong in the global warming is not that much the human activities but, rather the very low efficiency of the classic “heat to work” and then to electricity conversion, dictated by the classic thermodynamics, engines and turbines.

Example: while the science of electronics made several leaps forward after the second world war, the basics of the classic thermodynamics and engine concepts did not advanced since the time of Otto, Diesel and Boltzmann or, for over a century till now.

At long last, this invention changed that situation with the discovery of the Bezentropic Thermomechanics, allowing to construct zero polluting and more efficient heat engines, turbines, thermal and nuclear BEZENTROPIC power plants. All that should expand its influence into other branches of the science and technology, and even in the medicine.

In the opinion of this inventor-scientist, only through such new research and development can be solved the difficult global pollution and warming problems.

### IN THE ACCOMPANIED DRAWINGS

FIG. 1(a,b) represents the means of production of hydrogen of one original low temperature Redox process with sun energy.

FIG. 2 stands for chemical plant converting the methane gas to the more advantageous liquid Acetal fuels and antiknocks of supreme Octane Number (O.N.). The same plant is capable of producing Fuel alloys from biomass and then to obtain from them gaseous and light hydrocarbons trough acidolysis.

FIG. 3(a) represents the bladeless STATOR of the Bezentropic turbine

FIG. 3(b) is the ROTOR of the turbine and its SPIRAL canals.

FIG. 3(c) is the OVAL FLAT nozzle blowing its supersonic jet inside rotor's spiral canals

FIG. 3(d) represents the COMBUSTION CHAMBERS of the turbine

FIG. 3(e) displays the insertion of the rotor inside the stator of the turbine

FIG. 3(f) displays the general view of the BEZENTROPIC TURBINE, built in the “RADOMIR METALS Co” near the Capital Sofia of Bulgaria.

FIG. 4 sands for one even more efficient cryogenic (freon) type Bezentropic turbine

FIG. 5(a) represents the classic Nozzle of LAVAL.

FIG. 5(b) shows the parameters P, V, t and W of the nozzle of Laval for steam.

FIG. 6 is introduced to give visual idea how the disclosed rectification of the DISORDERLY vibrating gas and steam molecules (inside own tiny bubbles) become rectified into collinear (monodirectional) molecular jets of supersonic velocity. That process is spontaneous and fully converting the internal heat energy—of the gases and the steam—into linear kinetic energy having efficiency of 99%; thus, defying the 2nd law of the classic thermodynamics (the Entropy) and signaling the existence of the law of the Bezentropy.

FIG. 7 is the improved Bezentropic Vortex tube of the invention, performing separation of the molecules of higher temperatures from these of lower temperatures.

FIG. 8(a,b,c) displays the discovered—by the inventor—the 2 rotary centers of the ellipse and the mathematical formula from where one may calculate their coordinates, allowing better elliptic compressors and engines.

FIG. 8(d,e) and FIG. 8(f) show how said rotary centers are used for elliptic rotary engines.

FIG. 9(a,b,c) displays how to build semi Bezentropic Toroidal engine with extended expansion and significant conversion of the heat to kinetic energy.

FIG. 10 represents superior freon using toroidal engine of increased efficiency by extracting supplemental heat from the atmospheric air through VORTEX TUBE.

FIG. 11 is another bezentropic turbine using freon rain, freonfall and freon hydraulic turbine

FIG. 12 is vortex propulsion system. FIG. 15 is rough model of MITOCHONDRIA'S nano turbine

FIG. 13 displays the internal rough equivalent of MITOCHONDRIA'S internal construction.

FIG. 14 is BEZENTROPIC WIND TURBINE.

FIG. 15 depicts prospection & mining of METHANE HYDRATES.

FIG. 16 clarifies how one can use the poisonous H₂S gas as absolutely clean fuel.

### THE ART AND THE BACKGROUND OF THE INVENTION

As already mentioned the true solution of the global air polluting and warming problems requires the abandonment all of today fuels, heat engines, turbines and the expensive electricity of the contemporary thermal and nuclear power plants; then replacing them with hydrogen, hydrogen driven engines and vehicles, electric cars and zero polluting metallurgical, chemical and power plants.

Evidently, this is extremely difficult task because, there is no free hydrogen in the world, nor, inexpensive and zero polluting technology to derive it from water, hydrocarbons or coal. Beside the clean hydrogen as source heat and fuel for car engines, the electricity is another convenient and absolutely clean energy but, it is also not freely available and must be generated from some primary fuel. Moreover, most of it is now derived through expensive, inefficient and polluting thermal and dangerous nuclear power plants because, deriving it from waterfall power plants is very limited on account of shortage of waterfalls.

On the other hand, like all heat engines the contemporary thermal and nuclear power plants cause enormous losses of heat, not available for conversion to electricity, due to the limitation of the second law of the classic thermodynamics, known also as the Law of Entropy. These losses are, in the average of 70% from the original input of heat.

Consequently, energy saving by using the classic thermodynamics engines and turbines is but, full nonsense.

# Another major problem facing the solution is: the existence of over one billion transportation vehicle and agricultural tractors in the world. Consequently it is not realistic to believe that they all can be replaced, in a few years, by hydrogen and, electricity using cars, trucks and agricultural tractors. The present industry simply cannot produce them in such short time, nor is able to convert sufficient gas stations to hydrogen and electricity supplying stations in order to promote worldwide popular interest in zero polluting vehicles.

On the other hand, the industry needs billions of wealthy people to by such vehicles in order to built them and distribute them for sale. Due to all of the above it is more realistic to say that the main goal all this invention would take 20 to 40 years to be accomplished, should it become main goal at leas to all countries of the EUROPEAN UNION.

Any way, we must start that process right now. Otherwise the already started global warming may not be avoided at all. Moreover, while waiting to see the effects from the desired radical solution, the industry would do better to produce the CLEAN ACETAL FUELS of this invention. They of course exhaust but, like the methane, only reduced quantities CO₂ and do not require any changes upon the existing vehicles, in order to be used; they can immediately contribute to the main goal of the invention and would smooth the transition to the desired electric and hydrogen using cares.

The BACKGROUND of the invention started in 1974—after the FIRST ARAB OIL EMBARGO— which prompted the inventor to develop, file and obtain his 2 USA patents dealing with synthetic fuels and hydrogen, derived from his FUEL ALLOYS. Then, followed his USA patent for a POWER PLANT using clean liquid (colloidal) coal fuel, all mentioned in the first page of this invention. Following that tradition, the inventor later developed the more advanced art and claims of this invention.

### The New Art of the Hydrogen Manufacturing

It consists of a treble plurality (set) of processes having as common ground inexpensive zero polluting processes in manufacturing of the hydrogen. The first one is a REDOX (Reducing+Oxidation) process, obtained by modifying the reaction yielding sodium manganate Na₂MnO₄—a dark green rocky substance—by conducting it in the absence of air and adding to the reaction Talk (hydrated Magnesium silicate) 3MgO.4SiO₂.H₂O, to facilitate the followed Hydrolysis of the so obtained rocky Sodium Manganate. The hydrolysis reverts back the initial reactants—the Sodium hydroxide (NaOH) and the pyrolusite (MnO₂)—needed to start with tem a new round of the process.

Hence, the first reaction at 250°+C. produces hydrogen, while the second produces oxygen as follows:

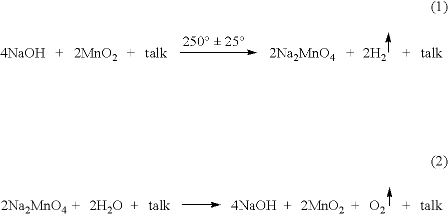

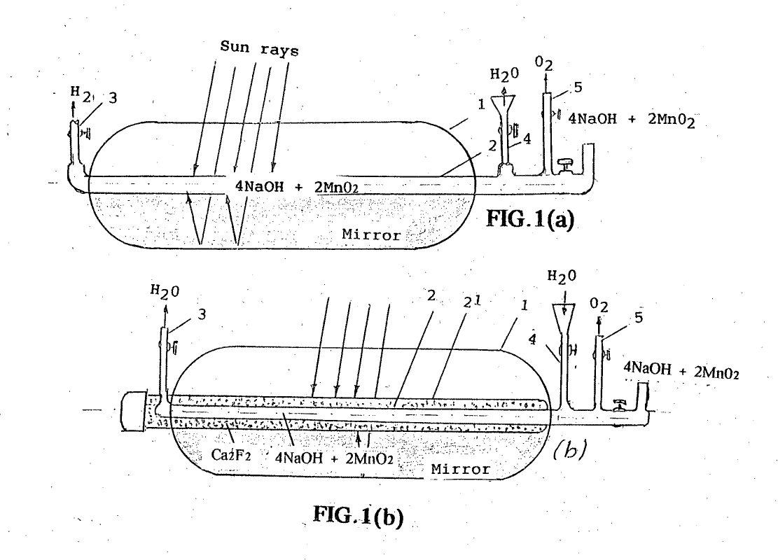

Since the required temperature of 250°+C. (to fuse the NaOH) is relatively low, the reaction (1) can be conducted with sun energy as shown on FIG. 1. There detail 1 represents a cylindrical mirror in the shape of half silvered and inflated transparent plastic cylinder; where its transparency faces the sun's rays. Along the axes of the cylinder is fixed the heat resistant, transparent tube 2—made from quartz or Pyrex. It is initially filled up with the necessary mixture of NaOH and MnO₂. The sun's rays, concentrated by the said cylindrical mirror, raises the temperature of the mixture to the necessary amount and start the above reaction (1), producing the desired hydrogen, then evacuated the tube 3.

It is important to keep the tube of reaction (1) out of air or oxygen, for otherwise instead of hydrogen is obtained water steam.

To start reaction (2) is needed to introduce—through tube 4—the necessary quantity of water. Reaction (2) work, practically at any temperature, and the obtained oxygen is evacuated through the tube 5.

During night time or, on cloudy days, the reaction's tube 2 should be taken out of the cylindrical mirror 1 and be heated by the stored ‘sun heat’ in granulated CaF₂—Calcium fluoride. The heat-storage device, given on FIG. 1(b), is of the same construction as that of FIG. 1(a), the only difference being that when such device is used for storing heat, its tube 2′ should be filled up with CaF₂ in order to collect sun's energy and then to heat tube 2.

The system of FIG. 1(a+b) is practical for production of small, to medium, quantities of Hydrogen+Oxygen. The fuels industry is enormous. Hence, large amounts of Hydrogen produced that way would require enormous acreage for capturing, using and storing the necessary sun energy; also enormous number of devices like these of FIG. 1(a,b) and of chemicals and chemists must be used.

For these reasons it is much more practical to produce large amounts of hydrogen trough the equally pollution free process, of this invention, using the endless existing amounts of Methane Hydrates and even the polluting ‘hydrogen sulfide H₂S’ of the Black Sea and the oceans but, in pollution free manner as teaches this invention.

The essentials of its new, pollution free and inexpensive technology for production of large amounts of inexpensive hydrogen, plus by-produced oxygen, is based on the more efficient Bezentropic thermomechanics and power plants of the invention, having the potential to produce more than three times less expensive electricity, when the Methane Hydrates and the H₂S are used as primary source of energy, as said in pollution free mode.

Once having such inexpensive electricity, the rest of the process consists of the (known to the chemists and to the physicists) classic electrolysis of the water. That way hydrogen and oxygen have been produced for over a century but, only in small amounts (4% to 5% from the world wide production) due to the expensive electricity.

According to Russian, Ukrainian and German geophysicists and geologists who explored the Black Sea for years, there are enormous deposits of Methane Hydrates which may last as source for methane—for the entire world—up to 64,000 years at the present world consumption of fuels. Even if said estimates are 10 times wrong, that only energy deposit may still last 6,400 years. Such deposits exists also in the oceans and in the North Sea, near Alaska and other places. Hence, the Methane Hydrates are the most reliable source of fuel deposit for the near and the distant future of human civilization. Moreover, Black See contains also a lot of H₂S which is easier to be mined and when conbusted in fluidized bed in the presence of CaCO₃ it produces only heat and valuable clean gypsum. Another reason for developing these patent's teaching how such fuels can be converted to hydrogen and electricity without exhausting any amount of CO₂ in the atmosphere thus to avoid the greenhouse effect of the CO₂ and the METANE.

THE METHANE HYDRATES are solid substances, compounded from Methane gas and water, obtained at temperature below 10° C. and pressure of over 20 atmosphere, regularly found at the bottoms of the deep seas and oceans. At such conditions the Methane Hydrates are stable and last for millions of years. But, when brought to the—surface of the sea, they spontaneously decompose back to Methane gas and water go back to the sea.

PRESENTLY, the only problem with the Methane Hydrates is the lack of one reliable method for mining them. That is why they are considered to be a fuel of the near future.

The important merit and task of this invention is namely the herein disclosed discovery of its unique for the time being reliable method for mining and for less expensive geophysical prospecting of Methane Hydrates, in the following way:

Depending on the purity of the Methane Hydrate, the Methane yielded from them varies from 150 m³ to 300 m³ of CH₄ per 1 m³ of Methane Hydrates. Due to that diversity, even when the place of the deposit is preliminarily established, the mining company still needs supplemental geophysical detailisations to begin mining at the best possible location.

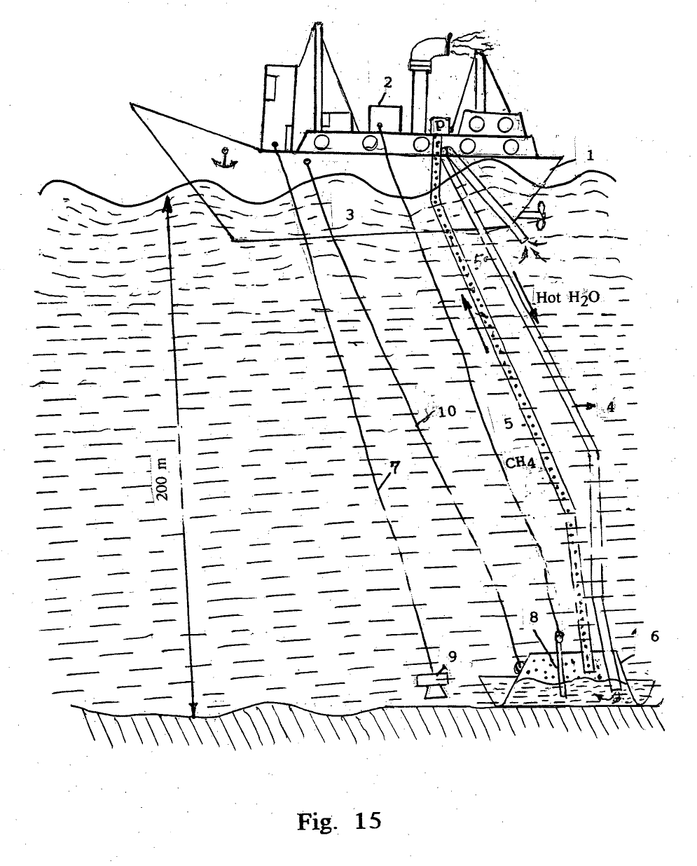

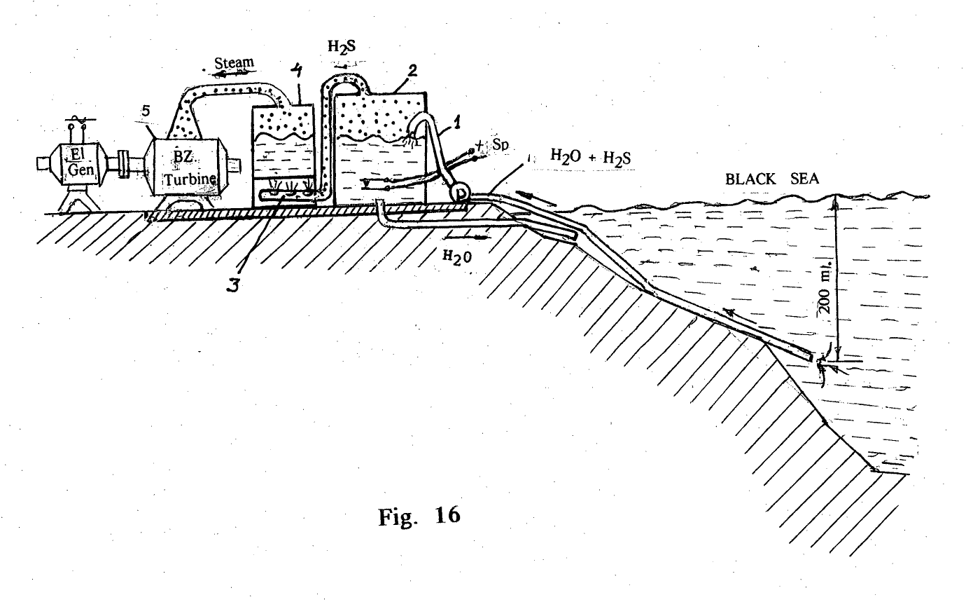

The inventor abandoned the classic geophysical methods of prospecting and developed a better, faster and less expensive method for the case of the Methane Hydrates. It is best explained by FIG. 15 where 1 is a relatively a small ship or floating platform having: its own electric power plant 2, of few MW; a reel (not shown on FIG. 1) on which is wound the long cable 3, joined with the hoses 4 and 5 all of them going inside a diver's like bell 6. A water pump (not shown on the drawing) helped by the hose 7 suck —relatively hot water from the surface of the sea (during the summer it is 25° C. to 32° C.) which after additionally heated—by a heat exchanger connected to the exhaust pipe of the power plant—is pumped inside the bell 6 through the hose 4. Concurrently, the special spark plug 8 inside the bell 6 causes several strong underwater electric explosions through electrical short circuits leading to decomposition of the Methane Hydrates into METANE and WATER. The so liberated CH4 is transported to the ship 1 through the hose 5. There, it is either compressed and liquefied or back converted to Methane Hydrate, for easier storage and transportation to the nearest sea shore.

The underwater TV camera 9 connected to the ship through cable 7 serves for visual information about the operation of the geophysical search for Methane Hydrates—deposited on the bottom of the sea. Detail 10 is nylon rope trailing the bell 6. The search and the mapping of the deposits are facilitated by a GSP (Geo Static Positioning System) allowing for the development of the necessary system of geophysical research profiles. LARGE IN SITU MINING OPERATIONS SHOULD BE CONDUCTED THE SAME WAY when is used a large professional platform, possessing several bells and TV cameras as these above described and the necessary power plant must be of bezentropic construction in order to obtain inexpensive electricity, CH₄, hydrogen and the clean intermediary acetal fuels.

The said very inexpensive safety hydrogen is derived from the so obtained CH₄ in the following way: near or, next to the involved sea shore, a large Bezentropic Power plant is built having intrinsic ultimate efficiency. That efficiency, combined with the inexpensive methane fuel used by the power plant (obtained from the Methane Hydrates), produces very inexpensive electricity. The combustion of the CH₄ inside the Bezentropic turbine naturally produces heat, and a powerful JET of gas mixture of Nitrogen (N₂), the burdensome Carbon Dioxide (CO₂) and synthetic steam the JET is used by the turbine to produce inexpensive work and electricity The carbon dioxide is separated and removed from the N₂ by dissolving it in water under pressure and dumped in the see while the N₂ is, saved. Alternatively, the CO₂ can be removed also by absorbing it in MONO, DI or TRI-ETHANOLAMINE at atmospheric pressure and then returned it to the see upon warming. The so recycled ethanolamine is saved for another use. The CO₂ dumped in the see combines with the numerous alkali earth ions there and is converted to neutral alkali earth carbonate rocks and sediments, falling down to the bottom of the sea. Mother nature created the LIMESTONE and the DOLOMITE rocks exactly that ecological way. Such Bezentropic Power Plants could be built also near any big rivers like the DANUB for example.

The by-produced NITROGEN is then blended with 10% to 40% hydrogen to obtain different grades quieted (safety) hydrogen (again like Mother Nature quieted the even more dangerous oxygen). The quieting allows to safely piping the hydrogen to the homes and to the different industries and is permitting safe compression and liquefaction of the hydrogen. On the other hand the METHANE obtained from the decomposition of the METHANE HYDRATE can used transportation vehicle until the advent of the hydrogen cars.

Naturally, part of the CO₂ can be blended with the quieted hydrogen to obtain the valuable SYNTHESIS GAS thus eliminating the polluting coal for synthesis of METHANOL, AMMONIA, FERTILIZERS, FORMALDEHYDE, PLASTICS, SYNTHETIC RUBBER, LUBRICANTS, SURFACTANTS AND SO ON; thereby reforming the entire industrial chemistry and the metallurgy to make them less polluting less expensive and more conforming with the main goal of this invention. Another advantage from this invention is using the methane hydrates and the methane for manufacturing of the said intermediary Acetal fuels and antiknocks of this inventor. Other best chemical feed stock to synthesize them are the hydrocarbons derived from inventor's fuel alloys, as well as, from methane.

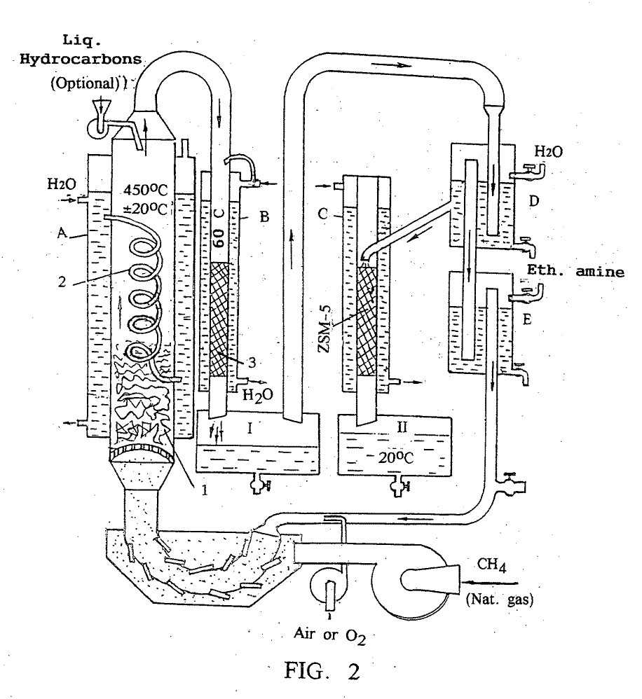

FIG. 2 displays the tubular chemical reactor for manufacturing said Acetal fuels, consisting of sections A, B, C and D. It works by catalytic partial oxidation in the presence of insufficient air or oxygen, performed in section A. There the used catalyst, 1, consists of 99.99% pure electrolytic copper. The required temperature is 440° C.±20° C. The necessary pressure is atmospheric, to no more than 40 atmospheres (if avoiding large reactors and constructions is preferred).

The continuous catalytic partial oxidation yields a flow of intermediary synthesis blend of aldehydes, alcohols and negligent amount of ketons. The main amount there, in descending rates, is the formaldehyde followed by the acetaldehyde, methanol and some ethanol. When propane, butane or, preferably, the hydrocarbons from inventor's FUEL ALLOYS, are added to the feed stock, this increases the amounts of the acetaldehyde and the ethanol; propanal, buthanal, isopropyl and butyl alcohols appear there in small amounts but, In general, the amounts of the aldehydes are twice as more as the alcohols.

Since the catalytic oxidation is EXOTHERMIC, section A of the reactor must be carefully cooled by circulating water inside the copper serpentine 2 (made like the catalyst from 99.99% pure electrolytic copper) to keep the above required temperature interval of the reaction stable. The catalyst could be either copper sponge or spiral copper wire.

There is no need to separate the products of the catalytic oxidation because, such a mixture produces a bouquet of acetals, which perform better as fuel, and as anti-knock, than the single acetal. Moreover, this saves as well on investment. The duration of the oxidation process lasts only about 0.4 seconds.

The so obtained bouquet of aldehydes and alcohols is then passed into the second section B of the reactor, using the second zeolite catalyst 3 doped by CaCl₂. The blend, obtained from the partial oxidation, is then sprinkled with water, to absorb and cool down the aldehydes and alcohol blend down to about 50° C. Then, under the influence of the catalyst, appears the bouquet of the desired fuel acetals, dissolved in the water having boiling temperatures from 44° C. to 150° C. Then, in order to have summer acetal fuel, the fraction between 44° C. and 89° C. is first distilled, while the rest is distilled as winter acetal fuel. The distillation proceeds in section C of the reactor, and then in separate distiller is performed a second distillation because the formaldehyde intermediary feed stock contains around 60% water which cannot be eliminated by one distillation. Such problem do not exist when instead of formaldehyde is used acetaldehyde since it do not contain water.

Because section A of the reactor produces twice as more aldehydes than alcohols, half of the obtained aldehydes stay unreacted. To avoid such a loss, half of them are passed inside section D of the reactor, where they are hydrogenated to their corresponding alcohols, and then blended with the other half, inside section B, to be converted to additional acetal fuels.

Moreover, looking for clean fuel diversity, this inventor modified entirely the well known MOBILE OIL PROCESS (converting the METHANOL into a light gasoline consisting mainly of HEXANE obtained by passing the Methanol through the synthetic zeolyte ZSM-5). Said complete modification consists by replacing the methanol with said unreacted extra aldehyde blend of the partial oxidation in the reactor by passing that extra blend trough said catalyst ZSM-5 replacing the methanol. Aa similar light gasoline is obtained consisting again mainly of hexane. The hexane however evolves more CO₂ plus some small other pollutants, and is of lower octane number than the acetal fuels.

Therefore, it cannot compete with them. Anyway since the hexane is less polluting than the other kinds of gasoline, this discovery makes sense to be used for manufacturing additional acetal fuels from it.

The involved chemical formulae of the PARTIAL CATALYTIC OXIDATION

### And of the Synthesis of Acetal Fuels are

The partial catalytic oxidation of the methane yields: aldehydes, alcohols and some ketons (mainly acetone) or:

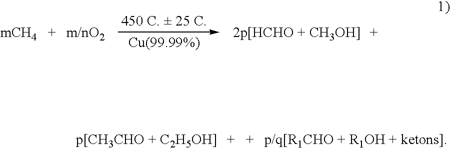

Reactions similar to the above can be performed with any other hydrocarbon, even with crude oil, but, are not preferable since that introduces also the cancerogenic cyclic hydrocarbons and the dioxine formed during such fuel combustion as well.

The next formulae of the synthesis steps are related to the catalytic conversion of the above intermediary products to acetals in order to accomplish them, the vapor phase of said intermediary products should be sprinkled with water to absorb the aldehydes and convert them to liquid phase; because, the dry (gaseous) formaldehydes do not react with the alcohols. The said liquid phase is then blended with a powdered zeolite catalyst doped with CaCL₂ and passed to section B of the reactor. The following reactions first produce hemi (half) acetals and then the desired acetals

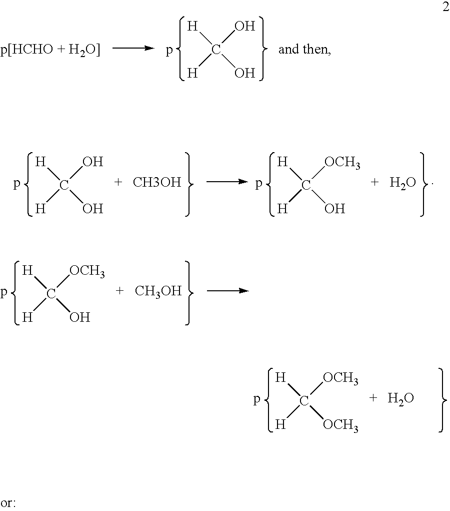

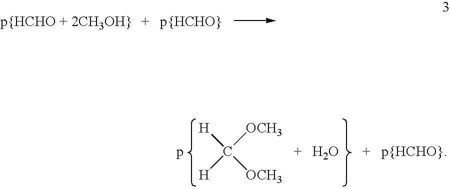

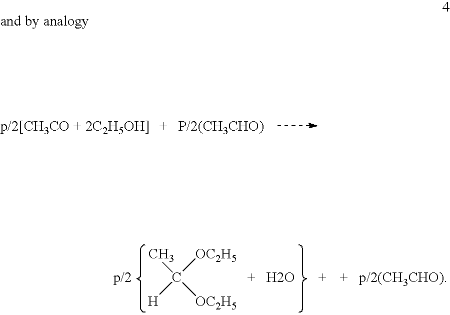

Part of the above reaction yield also mixed acetals as follows:

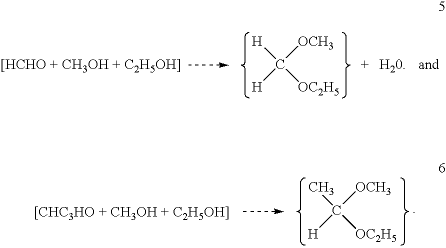

in the above conditions it becomes clear that the general formula of the HEMI ACETALS is

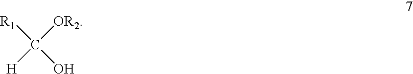

and that the generalized formula of the acetals is:

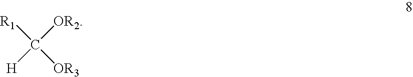

The inventor arrived at the idea of the acetal fuels as follows:
originally I was looking for new high octane antiknocks to replace the alkyl lead antiknocks found in gasoline as they are very poisonous and cancerogenic. Within this context, I first examined theirs structural formulae and properties.

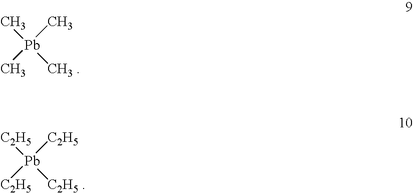

Examining them, I concluded that theirs high octane number (O.N.) of 114 is not due to the lead atom, but, rather to the existing ‘4 valences property’, bounding 4 alkyl radicals. Once arriving at that conclusion, I decided to test it, by replacing the Pb atom with another atom having 4 valence electrons and selected for that purpose the carbon C, trying to attach to it there different radicals. This led me to the formulae of the HEMI ACETALS and to the ACETALS. To my surprise, the experimental tests (performed first in the Bulgarian PLASMA REFINERY) indicated that the octane number of any acetal surpasses those of the alkyl lead compounds and are ranging between O.N.=123 and 150.8. On the other hand, the Road Tests performed several times both in Bulgaria and in the United states, showed that the acetals are not only the BEST ANTIKNOCKS, but, (except for hydrogen) are also the best engine fuels since are free of cancerogens, exhaust less CO₂ in the atmosphere (in comparison with the gasoline and the diesel fuel) and emit no other pollutants.

Moreover, the road tests displayed: that when to the acetal fuels is added 4% to 8% water, the water dissolves in them and cool the car engine internally, through its latent heat of vaporization, yielding up to 15% more mileage. Hence, they are really the best fuels to be used until the arrival of the hydrogen and the electric cars.

The Advent of the Bezentropic Thermomechanics and its Applications

As already said the RADICAL SOLUTION of the GLOBAL WARMING and AIR POLLUTION PROBLEMS can be solved only by abandonment all present liquid fuels, the coal, all transportation vehicles, all thermal power plants, the home gasification and the biofuels, replacing them with hydrogen, electricity and new engines driven either by hydrogen or electricity.

At first glance this sound like a MISSION IMPOSSIBLE since this world has no available free hydrogen and free electricity. So, they must be generated from the polluting fuels, engines, thermal and nuclear power plants of low efficiency, imposed on them by the Second Law of the Thermodynamics, meaning having the electricity always more expensive than the already expensive classic fuels. It appears that adopting such policy, the air pollution could never be solved even if all cars are converted to electric for that only will move the air pollution from the cars to the power plants.

Fortunately, this invention changes the above pessimistic picture by the disclosed discovery of the LAW OF THE BEZENTROPY.

The saga of said discovery started near the end of the second world war, when the inventor was a student-physicist in the University of Sofia. Then, while he agreed ‘de facto’ with the established Second law of the thermodynamics a.k.a., LAW OF the ENTROPY [since no classic heat engine could defy the efficiency barrier ε=(T₂−T₁)/T₂; (T=273+t° C.) of the cycle of Carnot] he never agreed with its mathematical proof made in 1841-43 its discoverer—the German mathematician RUDOLPH CLAUSIUS (1822-1888).

Inventor's argument was that said proof contains Gnoseological error (of the theoretical logic) consisting in the following:

A logical deduction (inference) must use as arguments (premises) only: axioms, mathematical theorems (inferred through axioms), temporary hypotheses allowing to be tested, experimental facts (like these of the chemistry & physics) and when such solid arguments are not available, acceptable are also POSTULATES (not evident, not logically or mathematically provable arguments but, accepted by repeated experiments from many independent experimentalists (like the postulate of Avogadro for example).

As is known, CLAUSIUS used as main argument to infer the ENTROPY the GEDANKEN (imaginary, not buildable) thermodynamic cycle and engine of SADI CARNOT. However, neither of them is AXIOM. Axiom is a logical argument which is absolutely evident for any one, without need for proof.

Evidently, the cycle and the engine of Carnot are NOT AXIOMS, for one needs to be a physicist, chemist or engineer to understand them. Moreover, they are not POSTULATES nor reliable hypotheses for being not buildable and therefore not experimentally provable.

CONSEQUENTLY, it is wrong to accept Carnot cycle's limit on the efficiency of the real engines and turbines.

Later, as a graduate student in the University of Paris the inventor discovered another hidden ERROR, made by CLAUSIUS, MAX PLANK and all scientists to present. It stems from the phenomena of the DISORDERED and the ORDERED MOLECULAR STATES of engines' WORKING BODIES (GAS and STEAM). CLAUSIUS, MAXWELL, BOLTZMANN, PLANK and others paid attention only to the DISORDERED MOLECULAR STATES of the gases and the steam as working bodies and never realizing that their COLINEAR ORDERED STATES promise SUPREME REAL EFFICIENCY in the HEAT TO WORK CONVERSION, defying the fictitious efficiency limit of the gedanken cycle of Crnot. This way, they were not able to forecast the startling event of the BEZENTROPY; since at that time (and till the advent of this invention) the BEZENTROPY was and is ‘tera incognita’ for all scientists.

### Coincidence Camouflaging the Gnoseological Error

Evidently Max Plank, was also troubled with the above GNOSEOLOGICAL ERROR of CLAUSIUS, for he tried to correct it, mathematically, using the Partial Differential Equations and the theory of the INTEGRATING DIVISORS.

Such approach however is fruitless, because, cannot uncover that the limit on the heat to work efficiency imposed by the CYCLE OF CARNOT is just a ‘SCIENTIFIC MYTH’, stemming from the impotence of the MOLECULAR DISORDERED STATES OF THE GASES AND THE STEAM.

Theoretically, MAX PLANK attempted to convert the differential quantity of the heat dQ into work by the working body (gas in full molecular disorder) given by the equation (a), not realizing (like all other scientists) that a MOLECULAR ORDER WOULD GIVE A COMPLETELY DIFFERENT RESULT, NOT COINCIDING WITH THE THEORY OF CLAUSIUS.

dQ=dU+A·Pdv (a)
where Q=heat in Kcal; U=internal energy of the working body in Kcals; P=pressure in ata; v=volume; P·dv=L=work in Jowl (or in Kg.m);
A=heat equivalent of the work; needed to convert the Pdv into Kcals thus, to obtain uniform dimensions for dQ, dU and Pdv

A mathematician or physicist would immediately recognize that the elemental work L=P·dv is PARTIAL DIFFERENTIAL because, it contains two variables: the P and v the full (total) differential of which is equal to

d(P·v)=Pdv+v·dP and not only P·dv (b)

It is correct to input in the mathematical model of the engine infinitesimal (differential) quantity of heat (and not finite one) because, in any piston engine or turbine the thermodynamic cycles contain curb lines, which do not allow to calculate by simple arithmetic the needed surfaces of the cycles (indicating the efficiency of the engines).

After this one must proceed to integrate—the so obtained differential surfaces—to obtain the final result.

Differently from the expression L=Pdv the member dU (the internal energy of the working gas) is ‘as is’ total differential since contains only one variable (the U). According to the to the rules of the calculus however, whenever to a total differential is added a partial one, the result becomes partial differential equation, like the (a) for example.

Consequently, it cannot be integrated ‘as is’, and must be preliminary converted back to total differential, in order to be integrated. There is no general rule for such conversion, but, in many cases a good path is to follow the THEORY OF THE INTEGRATING DIVISORS. Accordingly, such divisor is either a special number N, or a function N(x,y) of variables, which, when used to divide the PARTIAL DIFFERENTIAL EQUATION it is converted to TOTAL DIFFERENTIAL EQUATION, readied to be INTEGRATED.

Using such a routine, equation (a) is converted to the ARTIFICIAL Total Differential Equation

dQ/N(v,t)=(dU+A·Pdv)/N(v,t)=dS; (c).

where dS is the differential of the ENTROPY, or that part of the INITIAL heat Q inputted in the engine, obtained reducing the initial input by dividing it with the integrating divisot N(v,t), in order to be integrated.

The rest of the heat is thus EXHAUSTED by the engine as UNAVAILABLE as unavailable for conversion to work, creating unavoidable ENTROPIC LOSS. This loss amounts in the order of 70% to 80% from the initially inputted fuel of the engine.

Compare it with the also unavoidable losses caused from friction and radiation amounting to only 6% to 8% from the used fuel and then admire the ENTROPY.

The purpose of using the BEZENTROPY is to eliminate the loss from the entropy, thus promising efficiency of 92% to 94% in the HEAT TO WORK CONVERSION.

NUMERICALLY ONLY, the ENTROPY “S” is equal to the reduced quantity of heat B introduced by Clausius. He noticed that the heat behave very differently from all other form of energy in that only a small part B of it can be converted to work, the rest being exhausted without benefit for the user, just as heat unavailable for conversion to work. This statement of course is only part of the truth about the heat when considering the LAW OF THE BEZENTROPY. However, before the advent of this invention it was impossible to see and understand that the rule of the entropy is just a particular partial case governing the heat—caused by the MOLECULAR DISORDER OF THE GASES AND STEAM—and that the HEAT is ruled also more beneficially by the BEZENTROPY APPEARING SPONTANEOUSLY by NATURAL OR, ARTIFICIAL STIMULATED RECTIFICATION OF THE MOLECULAR DISORDER INTO COLINEAR ORDER.

Anyway, in order to deduce the entropy, Clausius subdivided the cycle of Carnot into series of similar small cycles represented by the following sum, also divided by the T:

B=ΔQ₁T₁+ΔQ₂T₂++ . . . =ΣΔQᵢTᵢ=∫dQ/T=∫(dU+Pdv)/T=S (d).

According to the theory of the integrating divisors, there are many such divisors Nᵢ, expressed by the equation

Nᵢ=N(v,t)·F(S) (e)

where the divisor N is a function of the volume v of the fluid (gas or steam) and F(S) is an arbitrary function of S.

Of course, Max Plank knew that the full energy of a fast moving volume of gas or steam is described by the full energy conservation law

Q=U₁−U₂+AL(P,v)+AG[(W₂²−W₁²)/2 g+(h₂−h₁)]AΣΔE (f).

leading to the following NATURAL TOTAL DIFFERENTIAL (g) which may well be integrated directly, but, only mathematically, NOT PHYSICALLY, because, all classic engine or, turbines are PHYSICAL INTEGRATORS for only PARTIAL DIFFERENTIAL EQUATIONS. Consequently the TOTAL ENERGY DIFFERENTIAL

dQ=dU+A(Pdv+vdP)=AG[dw²/_{2 g})+dh]+SΣdE (g).

where;
A=1/427 [Kcal/Kgm]=860 [Kcal/KWh] is the heat equivalent of the mechanical work L(P,V); G[Kg]=working body (gas or steam in Kg); W=velocity of the fluid; h=elevation of the fluid and E=to the rest of the not so pronounced energies, like these of the ionization caused by the spark plugs for example.

As said, no classic heat engine can integrate and convert to work above TOTAL DIFFERENTIAL EQUATION OF THE ENERGY (g). On the other hand Max Plank (as well as all scientist and engineers to present) did not know how to build BEZENTROPIC ENGINES CAPABLE TO INTEGRATE AND CONVERT IT TO WORK. This is why (being a realist) M. Plank turned to the partial differential equations of the energy to correct the GNOSEOLOGICAL ERROR of CLAUSIOUS since any classic engine and turbine is physical integrator and converter of the PARTIAL DIFFERENTIAL EQUATIONS OF THE HEAT TO WORK, but, no one to present realizes that this HANDICAP is due to the MOLECULAR DISORDER. Very probably Plank new that: whenever a NATURAL TOTAL HEAT DIFFERENTIAL is inputted into a classic engine, the engine SPONTANEOUSLY converts it to PARTIAL HEAT DIFFERENTIAL and then, the same engine is again SPONTANEOUSLY RECONVERTING IT, but, to the ARTIFICIAL TOTAL DIFFERENTIAL of the ENTROPY, in order to convert it to WORK, done by VOLUME EXPANSION, exhausting most of the heat as unavailable for conversion to work, termed ENTROPIC LOSSES.

To a great extent the creation of the entropic losses are due to the engineering construction of the classic piston engines, not providing sufficient space for expansion of the working body; because, in all of them the volumes of the expansion and the sucking strocks are equal. That defect is avoided now by the herein disclosed TOROIDAL BEZENTROPIC PISTON ENGINES of this inventor. As already said the major part of the entropic losses is due to the MOLECULAR DISORDER, not allowing the molecular impulses to get colineary united in JETS of KINETIC ENERGY, WHICH TANTAMOUNTS TO WORK. To some degree this defect is also alleviated by the TOROIDAL PISTON ENGINES, since they have no dead points and thus, beside theirs long circular volume expansion are creating also better conditions for KINETIC ENERGY, PUSHING THE PISTONS by MINIMIZED LOSSES.

The bezentropic turbines, of this disclosure, create the still better conditions for direct conversion of the heat to kinetic energy and work; ESPECIALLY, WHEN THEIR JETS OF COLINEAR MOLECULAR IMPULSES ARE ACCELERATED TO OVER 750 METERS PER SECOND, EQUAL TO TWICE THE SUPERSONIC VELOCITY.

Max Plank did not actually eliminated the GNOSEOLOGICAL ERROR of CLAUSIUS. He only proved that using the CALCULUS and the theory of the INTEGRATING DIVISORS leads to the same results obtained by the GEDANKEN cycle of Carnot. THAT OF COURSE IS COINCIDENCE NOT ERROR REMOVAL. He wrongly interpreted the COINCIDENCE AND BECAUSE OF THAT DID NOT TRIED TO EXPLAIN THE REAL CAUSE OF SAID COINCIDENCE WHICH IS SIMPLY UNINTENTIONAL CAMOUFLAGE of the ERROR.

Namely due to disregarding of equation (g) and using the Partial Differential heat input of equation (a), Max Plank arrived to the same equations of CAUSIUS:

dQ/T=dS=(dU+A·PdV)/T and (h).

S=dS=(dU+A·PdV)/T (i).

which Clausius derived them through the GEDANKEN CYCLE of Carnot.

Not having any idea about the BEZENTROPY, he was unable to find out also why ANY classic engine is intrinsically handicapped to accept only PARTIAL and NEVER NATURAL TOTAL DIFFERENTIAL of HEAT, like the ENTAPY dQ−dU+A(Pdv+vdP) for example.

That why is the MOLECULAR DISORDER, not allowing to create COLINEAR ORDERED JETS; in the men time concealing the internal kinetic energy of the molecules prompting the all directional vibrating molecules—inside tiny bubbles of diameter size equal to the median free path of the molecule—which by their eternal collisions liberate PHOTONS and give a false impression that the internal kinetic energy of the molecule is HEAT ENERGY.
Consequently, the disregard of energy expressions

‘+AG [(dw²/2 g)+dh]’ and (j)

‘+AΣdE’, (k).

of equation (g) transforms it automatically into equation (a) and acts as a ‘smog screen’ RESTRAINING to see the existence of the BEZENTROPY.

### Paradoxes Defying the Law of Entropy and Signaling the Existence of the Bezentropy

The concurrent existence of equations (a) and (g) and the conduct of all classic heat engines as mechanical integrators+heat to work converters, for only partial differentials of the heat energy, provided a hint to this inventor for possible but, not yet uninvented “new generation of heat engines”, capable for accepting and INTEGRATING DIRECTLY the NATURAL TOTAL DIFFERENTIALS of the HEAT, like the (g), (L), (m), (n), (o)

dQ=dJ=dU+A·(PdV+VdP)=ENTALPY (L).

dQ=A·G(W₂²−W₁ ²)/2 (m)

dQ=A·G·I(Ω₂²−Ω₁²)/2 (n)

dQ=A·G(h₂−h₁) (o)

and all combinations between them, all of which are NATURAL TOTAL ENERGY DIFFERENTIALS. Any physicist can integrate them directly but, only mathematically, not physically since no classic engine can do that. To do that physically obviously was needed new concept for engines and turbine, capable to integrate directly NATURAL TOTAL DIFFERENTIAL OF THE HEAT. A further study of that problem show that physically, the PARTIAL DIFFERENTIAL OF THE HEAT are created by the MOLECULAR DISORDER, causing impulse and energy subtraction from the TOTAL ENERGY DIFFERENTIAL OF THE HEAT. The alternative therefore, was the COLINEAR ORDERED MOLECULAR STATE, BARING SAID SUBTRACTION.

Moreover, at the turn of the 20th century LUDWIG BOLTZMANN (1844-1906) proved that the LAW OF ENTROPY is only a ‘statistical law’, not valid for microscopic volumes of gases and steam.

By 1915 the Russian physicist M. Smoluhovski showed that if one can build a microscopic heat engine, it would work in defiance of the Entropy and without fuel, on account of the BROWNIAN MOVEMENT inside of such engines, capture energy from the environment.

Delving further in the above problems and not finding a clue for solution in the classic thermodynamics 1, the inventor, turned to Mother Nature for help.

Fortunately, I discovered the following 3 PARADOXES of the ENTROPY, signaling laudly for the existence of the new ‘UNIVERSAL LAW OF the BEZENTROPY’:

### Paradox No 1 within the Mitochondria

One day, while walking in the Hollywood park and thinking about the above problems, I was suddenly struck by a mental revelation that my own existence and that of all human being and animals is duly prohibited by the Law of ENTROPY because: the entropy bars heat to work conversion without a temperature gradient, but, we don't have it. Then, to avoid the stress emitted by this annoyance, I immediately repeated the 400 years old philosophical saying of René DESCART: “Cogito ergo sum” (I think, therefor I exist). Obviously, there is a MAJOR CONFLICT between the ENTROPY and Descart.
Then who is right and who is wrong?

I solved this problem by reasoning: in order to work, any known heat engine needs a temperature gradient; not just of few Celsius degrees but, of hundreds such degrees to cover the losses from: entropy, friction, heat radiation and still produce mechanical work. This way the classic engines and turbines work and respect the low of entropy. Humans and all other living beings are biological forms of living engines and living power plants. They all convert the heat (derived from food) into mechanical work and bioelectricity, at constant temperature without temperature gradients. EXAMPLE: temperature change—not gradient—by only±5° C. to the human body, leads to death in less than one day without medical assistence. WHY IS THAT? Remembering the popular saying that the devil is in the details of the problems, I soon found the following satisfactory answer:

As already stated, BOLTZMANN proved that the law of entropy is only a STATISTICAL LAW, WHICH IS NOT VALID FOR ANY MICROSCOPIC SIZE of volume.

Eureka, I said. My body is entirely composed of microscopic cells; hence, THE ENTROPY is EXPUNGED. Consequently, there must be yet another, unknown alternative law since my body's cells convert the heat (obtained from my food) to work and to bio electricity at zero temperature gradient, which is strictly prohibited by the entropy. I named that hypothetical law ‘LAW OF BEZENTROPY’ (after the Bulgarian word ‘bez’, meaning ‘without’) and turned immediately to study the internal structure of the cells; in the hope of discovering its details and how to use it for practical purposes.

Looking for different medical articles, I found the following:

Beside the nucleus, inside the cytoplasma, of most living cell, there exists at least one small, cylindrical particle, termed MITOCHONDRIUM, covered by corrugated (wrinkled) membrane. Inside Its grooves, the oxygen—brought there by the blood—reacts with the glucose. That reaction is exothermic and its heat causes the Brownian movement inside the mitochondria at constant temperature. Then, I reasoned: since the cell produces bio electricity even though the only energy is the heat produced by the mitochondria, inside the mitochondrium must be some miniature (nano size) electrostatic type generator (to avoid the need for wires and electromagnets) plus a nano turbine, both rotating and united with the generator, in order to save room Inside the nano structure. On the other hand, since the cells are mainly built by proteins, themself built of AMINO ACIDS [polar substances having a basic (amino) radical and another acidic radical], it appears that the building material for said nano electrostatic generators is also aminoacidic for it is capable of being electrified. Reasoning further on. I arrived at the following rough equivalent electrical picture of the bezentropic conversion of the heat into work and to electricity Inside the mitochondria, given on FIG. 13. Some years an article wrote that British scientists, using the latest advance in microscopy succeeded in photographing the inside structure of the mitochondrium where a rotating nano turbine is visible, and they wondered how it work without a temperature gradient, nor noticed that it generates electricity. The explanation of these two puzzles is:

it works in defiance of the entropy for it is a nano structure where (in accordance with the theory of BOLTZMANN) the ENTROPY and the temperature gradient are expunged and such nano turbine operates as follows (see FIG. 13):

the teeth 4 and 5 of the toothed rotor 1 and stator 2, are shaped in a special way allowing only unidirectional rotation. 4 and 5 form also a series of elongated peripheral cavities 6, filled up by cellular plasma 3. The heat from glucose oxidation warms the plasma inside said elongated cavities—supplying the molecules of the plasma with internal energy dU—prompting a ‘to and fro reshuffling’ thus, rotating the rotor and pushing and rectifying the vibrating plasma into nano rotating flow, thus, converting the Internal heat dQ=dU into circular kinetic energy and the work

dQ=dU+A·I(Ω₂²−Ω₁²)/2 (p).

obtained without temperature gradient and the same rotation converts the work into static bio electricity due to said polarity between the teeth of the rotor and the stator, which is then collected from all cells through the nerve system, to be used by our brains and muscles, for intellectual and physical work.

# In a similar manner, the bezentropy ordains the existence of all trees, grass and agricultural cultures, again DEFYING the ENTROPY and promoting the entire flora in the world, since all plants grow, blossom, create fruit, grains and biomass, again without temperature gradients. The classic thermodynamics remains MUTE on the foregoing, but, not Mother Nature who created this way all life on earth. Consequently, the LAW OF THE BEZENTROPY IS THE UNIVERSAL LAW OF ALL LIFE (Fauna) and FLORA.

### Paradox No 2, Defying the Entropy in Large Volumes of Gas and Steam

Once discovering the Bezentropy in the nano volumes, I reinvestigated the works of BOLTZMANN, MAXWELL and de LAVAL looking for BEZENTROPY in large volumes. As said, Boltzmann proved that the entropy is just a statistical law, invalid for microscopic (nano) volumes of gases and steam. However, being statistical law mainly for large volumes of fluids, means that some times, in very special situations, the ENTROPY could be also invalid for large volumes of steam and gases. Boltzman never explored that possibility (probably due to his early tragic death). Furthermore, exploring the kinetic theory of Maxwell and Boltzmann I found also the lead that: said authors found that the internal heat energy dU of the gases and the steam is actually kinetic energy of their molecules, caused by all directional disordered molecular vibrations. As shown in the disclosure, that concealed internal kinetic energy dU≡u_{μ} is different for 1, 2, 3 or, more molecular gases and steam. Even more importantly, I noticed that within the vibrating molecules exists a valuable analogy with the vibrating electrons in the alternative current. That prompted me to search for ways to rectify the disordered and concealed molecular vibration into a mono directional flow of high velocity molecules. Examining, for that purpose, a diagram of the NOZZLE of LAVAL made by MAX PLANK INSTITUTE, I found that said nozzle is actually a RECTIFYING DEVICE converting, spontaneously, the disordered molecular vibrations of any gas or steam (assumed as internal heat energy) into linear kinetic energy with a 99% efficiency in FULL DEFIANCE of the LAW of ENTROPY and in SUPPORT OF THE LAW OF BEZENTROPY. The classic and quantum physicist missed that important fact because: whenever the said nozzle is attached to a classic gas or, steam turbine (to increase its efficiency) the result is failure, leading to wrong conclusion that the nozzle is also subjected to the LAW of ENTROPY.

Reviewing this problem, I found that the NOZZLE OF LAVAL is an EXCELLENT BEZENTROPIC DEVICE, which defies the ENTROPY, and converts DIRECTLY and SPONTANEOUSLY the heat into kinetic energy, by said 99% efficiency, in large volumes of gases or steam, doing it at SUPERSONIC VELOCITY when connected to BEZENTROPIC TURBINE. It cannot do that however with classic turbine. This PUZZLE is clarified as follows: WHEN A JET OF SUCH NOZZLE IS INTRODUCED IN THE ROTOR OF ANY CLASSIC TURBINE, IT STIKES IN CONSECUTIVE ORDER THOUSANDS OF TURBINE BLADES, CONVERTING SPONTANEOUSLY JET'S ORDER INTO FULL MOLECULAR DISORDER, INVITING BACK THE ENTROPY SLASHES THE EFFICIENCY DOWN TO MISERABLE VALUE

The conclusion from PARADOXES No 1 & 2 is that the Bezentropy is universal law of stimulated spontaneous RECTIFICATION of the MOLECULAR DISORDER into ORDER both in micro and macro volumes, while the ENTROPY is UNIVERSAL LAW OF THE MOLECULAR DISORDER. The lesson from this DUALITY is: whoever one wishes to build a more efficient turbine, HE MUST COMBINE THE NOZZLE OF LAVAL WITH A BEZENTROPIC TURBINE OR ENGINE HAVING BEZENTROBIC ROTOR AND STATOR OF THIS INVENTION. READ FOR THAT THE REST OF THE DISCLOSURE.

### Paradox No 3 Defying the Entropy in World Wide Volumes

PARADOX No 3 is related to the spontaneous bezentropic formation of clouds, rain waterfalls and the irrigation of all continents. It has enormous importance for the erecting the actually BEZENTROPIC BEZENTROPIC POWER PLANTS and the clarification that the entropy and bezentropy exist in nature independently of each other; without disturbing each other, even when they concurrently exist in one and same volume.

According to the LAW of ENTROPY it is impossible to produce work from heat without the followed temperature gradient

grad t=Lim[Δ(t₂−t₁)/Δx], when X→0 (q).

However, when the heat evaporates the water, the vapor is elevated to the clouds, performing work to create potential energy without a temperature gradient, even when the elevation in Δx≡Δh in formula (q) is not 0 but (say) a few meters. That is because, at elevation, the atmospheric temperature differences within a few meters practically never exists. In these conditions, such divergence between the air and the vapor also never exist at any altitude; hence the elevation, is adiabatic (without exchange of heat between the vapor and the air) since at any altitude the air and the vapor have same temperatures. Consequently, Mother Nature once again DEFIES the LAW of ENTROPY as follows

As is well known, water (and all other evaporable liquids) evaporate at any temperatures also below their boiling points. The ice and the snow even sublimate. The evaporation of the water, at boiling temperature, absorbs 540 K.cal./kg ‘latent heat of vaporization’. That heat inflates the volume of each 1K.gr. water to 1600 liters (1.6 m³) vapor. Moreover, at room temperature or, below, the ‘latent heat of the vaporization’ goes to over 600 K.cal./Kg. and the volume of the obtained vapor increases to more than 2 m³/Kg. In these conditions the VAPOR becomes lighter than the AIR (for 1 m³ of air weighting 1.033 Kg at sea level and ambient temperature), while 1 m³ vapor, at that same temperature and pressure, weighs roughly 0.5 Kg). Due to these conditions, as soon as any molecule of water is converted to steam, suddenly the LAW of ARCHIMEDES, is activated and spontaneously intervenes, elevating to the clouds, astronomical of tons of vapor worldwide per day, without temperature gradient, regardless of the temperature of the air, at a given altitude. That vapor is generated from the enormous surfaces evaporations of the sees, the oceans and the continents.

However, the spontaneous elevation of any kind of steam without a temperature gradient and zero divergence is always ADIABATIC process.

The steam elevation must respect the ENERGY CONSERVATION LAW and at said adiabatic conditions. Hence the only source of energy necessary for the elevation, is again the ‘latent heat of the vaporization’, 100% convertible also to heat of condensation. Consequently, little by little, part of the vapor's molecules condense into microscopic droplets of fog, thus, generating some ‘heat of condensation’ required to warm the rest of the steam's molecules and to reinflate each molecule's tiny bubble (of diameter size equal to the molecule's ‘mean free path) to keep active ARCHIMEDES’ force of the elevation. Concurrently the elevation creates POTENTIAL ENERGY. Hence, when reaching the clouds level, all ‘latent heat’ is exhausted creating POTENTIAL ENERGY of FOG droplets creating more clouds. This process of processes within the clouds converts the heat into potential energy of the clouds, is actually a BEZENTROPIC PROCESS of full conversion of the heat into POTENTIAL ENERGY, because, the heat of the condensation is always fully equal to the latent heat of the vaporization and because, the elevation of any weight at altitude ‘h’ is 100% POTENTIAL ENERGY. Consequently, Nature defies the LAW OF ENTROPY for a third time. Evidently Nature prefers to follow the better law of the BEZENTROPY whenever heat is converted to mechanical form of energy. Once again, the most essential point of the bezentropic conversion is the COLINEAR MOLECULAR ORDER of the elevation created by the combination of the latent heat of the vaporization and the law of ARCHIMEDES.

### Practical Applications Stemming from Paradox No 3

The practical applications from PARADOX No 3 are enormous. Some of them have been in use by humans for millennia, yet, not understood to the present, in that they are predetermined and foreordained by the law of the BEZENTROPY.

Its vast natural events are: the formation of clouds, rain, snow, the waterfalls and the irrigation of the entire planet; thereby causing and promoting the existence of life, the human civilization, the flaura and fauna on our planet.

Man's applications of paradox No 3 comprises: the historic water wheels, water turbines and HYDRAULIC ELECTRIC POWER PLANTS using by the WATERFALLS and together with Mother Nature performing BEZENTROPIC FULL CONVERSION OF THE ‘LATENT HEAT OF VAPORIZATION’.TO WORK, DOING THIS FIRST BY CONVERTING IT TO POTENTIAL ENERGY OF THE CLOUDS, THE RAIN AND THE WATERFALLS; THEN, to TO KINETIC ENERGY, WORK AND ELECTRICITY. Curiously, no one to present realizes that the WATER POWER PLANTS are ACTUALLY BEZENTROPIC THERMAL HYDRAULIC PLANTS; for no one of them can work without ‘LATENT HEAT OF VAPORIZATION’ and all of them are defying THE ENTROPY and follow the law of the BEZENTROPY.

### Bezentropic Turbines of Paradox No 3 Working Via Freon Rain

The ‘Water Power Plants’ are perfect ecological systems. However, they could never satisfy the world's demand for electricity; for there are no sufficient waterfalls. One answer to this shortage are the freon type bezentropic turbines, working In closed circuit, by artificial freon rain and freonfalls.

Differently from the water, the ‘latent heat of vaporization’ of most suitable freons are in the range of 30 to 35K.cals/kg., or 17 to 20 times less than that of the water. This allows to create, in closed tubular circuits system, ‘artificial FREON RAIN and FREONFALLS’ at acceptable altitude of 100 to 150 meters; freon type hydraulic power plants. More information about them is further given in this disclosure.

### The Concurrent Existence of the Entropy and the Bezentropy

From above 3 PARADOXES, becomes apparent that the dividing line between ENTROPY and BEZENTROPY is: the DISORDERED MOLECULAR KINETIC state of the GASES and STEAMS CAUSING THE MOLECULAR COLLISIONS, EMISSION OF PHOTONS AND THE ENTROPY and the COLINEAR OR CIRCULAR ORDERED MOLECULAR KINETIC STATE, AVOIDING THE MOLECULAR COLLISIONS, EMISSION OF PHOTONS AND CAUSING THE BEZENTROPY.

MOREOVER, the Bezentropy and the ENTROPY do not always expunge each other. They often occupy same volume at same time. Example: the elevation of the vapor (in Paradox No 3) is a clearly ordered bezentropic process, for all molecules of the vapor there are vertically oriented when elevate to the clouds; while the air molecules surrounding them are all ways in disordered state, not elevating, casing the Entropy but, not disturbing each other. Other remarkable cases of the concurrent existence of disordered and ordered phenomena of the entropy and the bezentropy are: the orderly T.V. and radio waves passing through the disordered molecules of the air, without disturbing each other. Similar is the case also with the phonons of the sound and the air.

Without such mutual tolerance between the phenomena of entropy and bezentropy we would never have radio, television and direct conversations.

### Lessons from the Above 3 Paradoxes

The first lesson and inference from the above 3 paradoxes is that: they all are concerned with MOLECULAR ORDER of the UNIVERSAL LAW of BEZENTROPY. Contrarily, the phenomena of the classic thermodynamics relying on the MOLECULAR DISORDER are subjected to the LAW of ENTROPY.

Accordingly, it is inferred also that the law of the BEZENTROPY expresses an UNIVERSAL LAW OF MOLECULAR ORDER while the ENTROPY represents the UNIVERSAL LAW of the MOLECULAR DISORDER. The second lesson is:

another Important inference that all classic heat engines, as well as the classic gas and steam turbines are mechanical integrators plus partial ‘heat to work converters’ only for the partial differential of the heat

dQ=dU+A·PdV (r)

which must be preliminary converted to the ARTIFICIAL TOTAL DIFFERENTIAL of the ENTROPY

dS≡dQ/T=dU in order to be integrated, where T=273+t° C. (s)

Contrary to that the BEZENTROPIC CONVERSION OF THE HEAT TO WORK don't need (r) and (s) because all bezentropic engines and turbines are direct physical integrators and heat to work converters of all NATURAL TOTAL DIFFERENTIALS OF THE HEAT, like the ENTALPY dj=dU+A(PdV+VdP) for example.

Notably, by observing the art of Mother nature, this inventor invented the new kinds of heat engines and turbines capable of converting—directly and fully—the natural total differentials of the heat into work, thereby eliminating the losses caused by the entropy.

Another stimulus for inventing them was to meet the MAIN GOAL of this invention, which can never be attained by the classic thermodynamics. All classic engines work in extremely wasteful manner: thus, whenever some NATURAL TOTAL HEAT DIFFERENTIALS are imputed in them (such as the ENTALPY dj=dU+A(Pdv+vdP) for example the engines spontaneously convert them to the inefficient PARTIAL HEAT DIFFERENTIAL dQ=dU+A·Pdv and then convert to the also INEFFICIENT ARTIFICIAL TOTAL DIFFERENTIAL of the ENTROPY dQ/T=dS=(dU+A·Pdv)/T; and only then to the very reduced quantity of WORK—allowed by the entropy—doing that by the integration:

§dS·T≡§(dQ/T)=·§(dU+A·Pdv)/T (t)

### Precise Definitions of the Entropy and the Bezentropy

Notwithstanding that both the ENTROPY and the BEZENTROPY are laws for heat to work conversion, devising a common definition for them is impossible because:

they address different phenomena caused by theirs DISORDERED and ORDERED molecular states. This DIVIDES the heat in 2 different GROUPS: one of them appearing as a INTEGRAL (sum of infinitesimal elements) of only NATURAL TOTAL DIFFERENTIALS of the HEAT, directly convertible to work by the LAW of the BEZENTROPY, while the other is always ARTIFICIAL TOTAL DIFFERENTIAL OF THE ENTROPY, multiplied by the absolute temperature ‘T’.

Any working body (gas or steam), following the molecular order, behaves differently from any working body in molecular disorder. Because of this difference they require 2 completely different families of turbines and engines: one named ‘bezentropic’ family of turbines and engines and the other ‘classic’ family of turbines and engines working differently, and converting only miserable part of the heat (inputted them) into work. Said classic engines and turbines follow always the INDIRECT PATH of the ENTROPY for heat to work conversion, while the BEZENTROPIC engines and turbines perform DIRECT heat to work conversion giving rise to the new SCIENCE OF BEZENTROPIC THERMOMECHANICS, RECTIFYING SPONTANEOUSLY the MOLECULAR DISORDER into COLINEAR and CYCLIC ORDERED JETS OF KINETIC ENERGY, EQUAL TO WORK.

Differently, the classic engines and turbines integrate only the ARTIFICIAL total differentials' dS of the ENTROPY; never NATURAL TOTAL HEAT DIFFERENTIALS.

All above leads to the more precise definition of the LAW OF ENTROPY, expressed as follows:

ENTROPY is the universal law of MOLECULAR KINETIC DISORDER, allowing integration [symbol] only partial heat differentials, leading to partial HEAT to WORK CONVERTION; Any attempt to input natural total differentials of heat in the classic engines leads to instantly converting them to PARTIAL HEAT DIFFERENTIALS; then only the engine converts them to ARTIFICIAL TOTAL DIFFERENTIALS of the ENTROPY to integrate and convert them into WORK. All classic engines and turbines are PHYSICAL INTEGRATORS and CONVERTERS only for PARTIAL DIFFERENTIALS of the HEAT because, they are NOT CAPABLE to RECTIFY the MOLECULAR DISORDER into ORDER. Rectifying the disorder into ORDER is spontaneous convertion of the internal molecular kinetic energy into LINEAR and CYCLIC KINETIC ENERGY, WHICH EQUALS TO DIRECT CONVERSION OF THE INTERNAL MOLECULAR KINETIC ENERGY TO WORK. The energy of the DISORDERED MOLECULAR EXHAUST THERE IS IMPOSSIBLE TO BE CONVERTED TO WORK AND CREATES THE ENORMOUS ENTROPIC LOSSES. Tuse the heat converted to work is only a small part left for that purpose, equal just to the REDUCED QUANTITY of HEAT ‘B’ of CLAUSIOUS, reduced from the originally imputed heat

dB≡dQ=(dU+A·Pdv)/T, which is—numerically—equal to the ENTROPY:

B=Limes Σ(ΔQᵢ/Tᵢ)=∫dQ/T=§dS=§(dU+A·G.Pdv)/T; where: i→; G[Kg]=working body; concurrently, the molecular disorder creates the largest ENTROPIC LOSSES UNAVAILABLE for CONVESION TO WORK attain 70% to 80%.

The BEZENTROPY is the universal law of stimulated (naturally or by men) spontaneous RECTIFICATION of the molecular kinetic disorder into ORDER, allowing direct and practically full conversion of the heat into work, because the rectified molecular kinetic energy of any gas or steam equals to work.

The Bezentropic processes are performed either by NATURE—as in the described 3 PARADOXES—or, by the BEZENTROPIC ENGINES and TURBINES of this invention. The said RECTIFICATION of the DISORDERED to ORDERED MOLECULAR KINETIC ENERGY acts as a perfect ‘physical integrator and converter’ of the heat into work; making all bezentropic engines & turbines DIRECT INTEGRATORS OF TOTAL DIFFERENTIALS of the HEAT. The BEZENTROPY also includes the VORTEX TUBE'S PHENOMENON. It constitutes a separation between the HIGH and LOW ORDERLY VIBRATING MOLECULES.

### The First Built Bezentropic Turbines and Devices

The proof is in the pudding says an old English saying. So to test the Bezentropy I decided to bake my Bezentropic pudding in the largest Bulgarian metallurgical combinate RADOMIR METALS Ltd not far from the Bulgarian capital SOFIA. As soon the contract was signed, I began the construction a 5 MW (Mega Watts) Bezentropic turbine for a Power Plant. It his is the first in the world ‘TURBINE WITHOUT TURBINE BLADES’, since the Law of Bezentropy eliminates them FOR BEING TROUBLE MAKER OF THE ENTROPY.

The differences between the classic and the bezentropic turbines are enormous and are both mechanical and thermodynamic. The classic turbines contain thousands of turbine blades upon theirs rotors and stators. They work by using gas or steam IN FULL MOLECULAR DISORDER converting the heat into work only through volume expansion, imposed to them by the LAW OF ENTROPY and never using the more beneficial COLINEAR KINETIC JETS.

On the contrary, the bezentropic turbines do not have turbine blades, and there the working body (gas, steam or, both) is in full colinear and cyclic molecular order, obtained through stimulated spontaneous RECTIFICATION of the molecular. DISORDER; THUS, CREATING MECHANICAL MOLECULAR JETs OF LINEAR and CIRCULAR KINETIC ENERGY FROM THE HIDDEN INTERNAL VIBRATING ENERGY OF THE MOLECULAR DISORDER (vibrating before their rectificaton in all possible directions); thus, yielding a full (100%) spontaneous conversion of the heat into work; and when desired, into potential or vortex energies. After that, the said mechanical kinds of molecular energies are converted, again in full, into work. The work is also mechanical phenomenon and, like any mechanical energy, is also full convertible into them and subject to the ‘Energy Conservation Law’ and to the LAW OF THE BEZENTROPY—PROMOTING SAID SPONTANEOUS RECTIFICATION (as explained by above 3 PARADOXES). Another difference is that the phenomena of the BEZENTROPY ARE NEVER SUBMITTED TO THE LAW OF THE ENTROPY. That is because the Bezentropy is sinonime of the ORDER while the Entropy is sinonime of the DISORDER in the world. The conversion of the ORDER into DISORDER and vice-versa however is possible

All secrets of the bezentropic process can be conveniently learned from studying the stimulated natural an artificial spontaneous rectification of the hidden molecular and KINETIC DISORDER into colinear and cyclic molecular order of the rectification, thereby creating mechanical molecular JETS—porters of kinetic energy—and keeping this order, until it is fully converted to work by the bezentropic rotor of the new turbine. The said stimulated spontaneous rectification (named bezentropy for short) can be attained either through a ‘nozzle’ (like that of LAVAL) or, by more suitable devices (further disclosed in this invention). To endure JET'S order, until its full conversion to WORK were invented SPECIAL, BLADELESS BEZENTROPIC STATOR and ROTOR, again further disclosed in this paper. Only thist way, is possible to EXPUNGE the less productive Law of Entropy and replace it by the much prodigious LAW of the BEZENTROPY.

The theoretical ground of the ‘LAW OF THE BEZENTROPIC RECTIFICATION’ is explained, taking into account the ‘kinetic theory of the gases and the steam’ developed by JAIMS MAXWELL (1831-1870) and LUDWIG BOLZMANN (1844-1906), and as well, as the phenomena of the above disclosed PARADOX No 1, PARADOX No 2 and PARADOX No 3 discovered, disclosed and explained for first time by this inventor. Stated in brief, the THE LAW OF THE BEZENTROPY consists of RECTIFYING THE ‘HIDDEN VIBRATING KINETIC ENERGY OF THE DISORDERED GAS OR STEAM MOLECULES into MORE EFFICIENT and TANGIBLE MACRO MOLECULAR MECHANICAL JETS, PORTER OF KINETIC ENERGY WHICH IS FULLY CONVERTIBLE TO MECHANICAL WORK.

The rectification therefore CONVERTS—THE OTHERWISE NOT USEABLE—KINETIC ENERGY OF THE SAID VIBRATION, into USEABLE KINETIC ENERGY OF COLINEAR AND CYCLIC MOVING MOLECULES.

According to the Kinetic Theory OF THE GASE, the internal energy ‘U’ of any gas—usually counted as HEAT ENERGY— is actually integral (sum) of ‘hidden molecular kinetic energies' of all directional molecular vibration. Maxwell and Boltzmann assumed that, statistically, said energy is distributed equally upon the degrees of freedom of the vibrating molecules, assigning to each degree of freedoms, the kinetic energy Eₖ=¹/₂kT where the temperature ‘T’ is proportional to said “hidden kinetic energy’expressed as

a·T=mW²/₂=³/₂·kT=U 10.

where ‘a’ is coefficient of proportionality equal to the ‘mean kinetic energy’ of the gas molecules at T=1K; being same for all gases (a=idem); while k=²/₃·a is the well known ‘constant of Boltzmann’ and U=Q=J is the internal energy of the gas, at constant volume.

Under these conditions, the internal kinetic energy for one mol (1μ) gas having Z degrees of MOLECULAR FREEDOM becomes:

u_{μ}=μu−A·N_{μ}Z¹/₂kT; 10.1

however, kN_{μ}=R_{μ}=848 (figuring in the basic gas equation P.V=R.T) and then, formula 10.1 becomes:

u_{μ}=¹/₄₂₇·484·¹/₂Z·T (Kcal/mol); 11.

consequently we have:

u_{μ}0.99255·3T=2.775·T≈3·T; 12.

for gas of 1 atom molecules (Z=3)

u_{μ}0.99255·5T=4.9625·T≈5·T; 13.

for 2 atoms molecules (Z=5) and

u_{μ}0.99255·6T=5.9550·T≈6·T; 14.

for 3 or more atoms molecules (Z=6)

It should be noted that when steam is preheated it comports itself like a gas. The above internal molecular kinetic energy is not free however. It is locked inside a near molecular size, tiny spherical volumes (bubbles)—of diameter size equal to the ‘mean free path’ of the all directional vibrating molecules. It stays that way consistently at constant temperature and pressure.

Whenever the said pressure increases or decreases the tiny bubbles, respectively, decrease or inflate their volumes Due to the eternal mutual collisions of the molecules, they—respectively—either emit or absorb photons, which we sense like heat or cold.

The classic thermodynamics allows for conversion to work only a small portion of that internal energy, performed only through volume expansion (by all classic engines and turbines) which is not good choice for energy conversion. That way, only a small part of the internal kinetic energy utilized and external kinetic energy is almost not existing because of the slow velocity of the expansion compared with the velocity of the all directional molecular vibration (being in the range of 80 to 1000 meters per second at The rest stay in its tiny bubbles unavailable for conversion to work and is exhausted ENTROPIC LOSSES

The locked internal kinetic energy, in said tiny bubbles (balloons), is enormous even at 0° C. and at 1 atmospheric pressure. This is best understood when the ‘average molecular velocity’ Wₐ is calculated even for mono atomic (ideal) working body. Wa is SUPERSONIC even at said freezing conditon. Consequently, it would be more advantageous to rectify that all directional vibrating kinetic energy, which is intrinsic form of mechanical energy, and therefore, directly and fully convertible to mechanical work; thereby, avoiding the inefficient entropy and its volume expansion process. Let's check this mathematically:

The pressure P of a working gas (of 1 atom molecules) pushing the walls of engine's cylinder (or upon the walls of any other container) is

P=²/₃n_{M}·(m·W²)/₂; 15.

where nM is the number molecules in 1M³ gas; m=mass of the gas molecules and W²=the geometric mean value of the velocity. Equation 15 displays that the pressure P of the ideal gas upon the walls of engine's cylinder is equal to. ⅔ from the kinetic energy of the molecules enclosed in a volume m=1M³ of such gas.

The average velocity Wₐ defined from 15 is

Wₐ=(W²)^{1/2}=(³P/n_{M}m)^{1/2}. 16.

However, because n_{M}m is equal to the mass of the molecules in volume of 1M³ gas, we can have also:

n_{M}m=γ/_{g}; 17.

then, from 16 and 17 is obtained the more practical value of Wₐ

Wₐ=[^{3 Pg}/_{γ}]^{1/2} 18.

In this way, from formula 18, the average molecular

velocity for the ideal working body, at temperature of 0° C. and pressure of 1 atmosphere, equal to 1.0332 kg/cm²; g=9.81 M and γₒ; _{760=1.293} kg/M³ can easily be calculated.

It is

Wₐ=[^{3·1.0332·9.81}/_{1.293}]^{1/2}=485 (M/sec mean free path)=1,746 (Klm/hour) 19.

The result is surprising SUPERSONIC VELOCITY of the ‘mean free path’ of the vibrating molecules at freezing temperature of 0° C., which should be much higher at higher temperature and pressure (like In the Diesel engines for example). That is ‘HIDDEN KINETIC ENERGY’, needing only to be RECTIFIED from its ‘all directional hidden vibration’, Into ‘one directional’ (colinear) molecular Jet Propulsion in order to work as regular kinetic energy thereby avoiding the wasteful Law of Entropy. So far, the BEZENTROPIC PROCESS OF RECTIFICATION consists of stimulating the disordered molecular vibration (causing said ‘hidden kinetic energy’) of SPONTANEOUS conversion into colinear Jet of ordered molecules. CONSEQUENTLY, THE LAW OF BEZENTROPY CAN BE DEFINED AS ‘STIMULATED SPONTANEOUS RECTIFICATION of the MOLECULAR DISORDER into ORDER; thus, converting the hidden internal energy of the working body (gas or steam) from hidden into real kinetic energy. Thereby, the law of ENTROPY becomes instantly eliminated from further consideration. This is because the KINETIC ENERGY is MECHANICAL and follows the MECHANICAL DYNAMICS, not the THERMODYNAMICS.

The best example for said Instant elimination of ENTROPY is the NOZZLE of de LAVAL. Laval's nozzle converts the HEAT ENERGY into LINEAR KINETIC ENERGY with a 99% EFFICIENCY, strictly. PROHIBITED by the CYCLE OF CARNOT, from which the law of ENTROPY is derived. That nozzle actually is effective BEZENTROPIC DEVICE causing SPONTANEOUS RECTIFICATION of the DISORDERED MOLECULAR VIBRATION Into ORDERED MOLECULAR JET. So let us examine its construction and work.

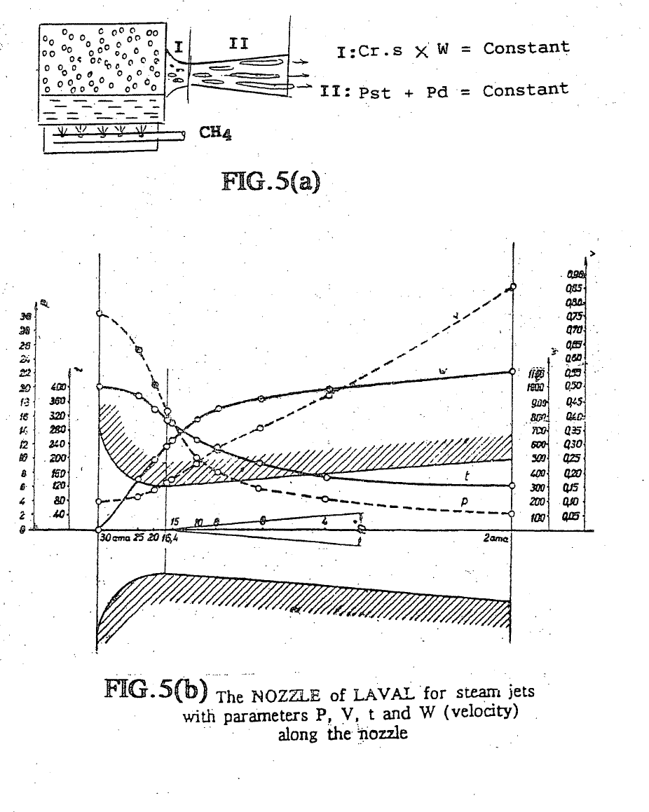

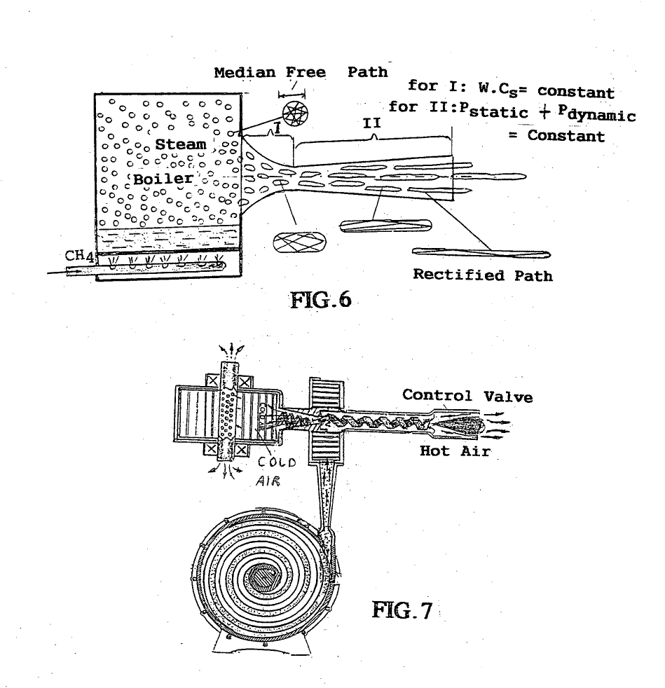

FIG. 5(a) represents the general construction of the NOZZLE OF LAVAL, connected to a boiler and consisting of 2 parts: Part I is of convergent construction and Part II is divergent The boiler is shown to clarify that each molecule of preheated steam generated there at constant temperature, pressure, volume and mutual collisions has no other chance than to vibrate—in all directions—inside a tiny bubble of ‘diameter size’ equal to the ‘mean free path’ of the molecule. That vibration makes its kinetic energy well concealed ‘internal energy’, appearing more or less as heat energy. This is because, the heat energy actually consists of a cloud of emitted free thermal photons, bouncing the molecules and causing the Brownian collisions liberating more photons anthill an equilibrium is reached. The absorption of the photons there is actually SATELISATION around the electrons of the molecules and the emission of the photons is DESATELISATION from there. Absorbing some photons, the quick silver of the thermometer becomes elongated and we wrongly interpret the internal kinetic energy of the gases as heat energy. Heat energy is only the energy is only the energy of the thermal photons. That however is not a major error since the CALORIES are convertible to JOULES.

Entering the converging Part I of the nozzle of Laval, the vibrating nano bubbles spontaneously become transformed into shapes of tiny needles, due to the colinear acceleration creating only longitudinal volume expansion, along the axis of the nozzle, prompted by the first LAW OF BERNOULLI:

W·Cₛ=Constant; 20.

where W=velocity and Cₛ=cross section. Then,

entering the diverging Part II of the nozzle, the working body is once again colinearly accelerated to supersonic velocity, following the second law of BERNOULLI:

Pₛₜ+P_{d}=Constant; 21.

where Pₛₜ=static pressure and P_{d}=dynamic pressure.

Hence, the average velocity of the so created MOLECULAR JET (of gas or, steam) goes up to 1200 (M/sec). at initial pressure of 22 ata, or nearly 4 times the velocity of the sound. As a result, the disordered vibrating bubbles become converted into—non vibrating—long “needles” of supersonic velocity; thus, RECTIFYING the HIDDEN KINETIC VIBRATION (OF THE MOLECULES) up to EFFICIENCY of 99% to almost 100% of HEAT TO KINETIC ENERGY CONVERSION. This is a phenomenon DEFYING FULLY THE LAW OF ENTROPY AND PRECISE PROOF DEMONSTRATING THE EXISTENCE OF THE LAW OF BEZENTROPY. This efficiency is verified, by internationally recognized authorities, like MAX PLANK INSTITUTE. Its experimental results and diagram are given on

FIG. 5(b). displaying again the NOZZLE OF LAVAL, but, joined by experimental curves of important parameters, along the nozzle, using water steam as working body.

Said parameters reveal the ‘stimulated (by the nozzle) spontaneous RECTIFICATION of the disorderly vibrating molecules of steam into a powerful Jet stream of colinear molecules. They are: Pressure P in ata; temperature t° C.; velocity W in M/sec; volume V; angle of divergence 100; imputed pressure (from steam's boiler)=30 ata going down to 2 ata at the exhaust of the nozzle.

Due to the obtained supersonic velocity and the short length of the nozzle, the acceleration of JET'S stream is ADIABATIC PROCESS. In this condition, the only source of the JET'S ENERGY comes from the initial ‘internal kinetic energy’ of the vibrating molecules, inside the boiler, named heat content or ENTLPY of the steam energy usually measured in Kcals/Kg.

Evidently, due to the adiabatic process of rectification, the HIDDEN kinetic energy (of all directions vibrating molecules) becomes converted into ‘TANGIBLE LINEAR KINETIC ENERGY’ of STEAM JET. Since the molecular rectification is adiabatic process, not changing the kinetic nature of the HIDDEN and TANGIBLE energy the energy conservation law is strictly respected without energy losses.

### The Advent of the Bezentropic Thermomechanics

The stimulated (by the nozzle), PROCESS of SPONTANEOUS RECTIFICATION avoids the ENTROPY, BUT, STRICTLY RESPECTS THE LAW OF THE ENERGY CONSERVATION (a.k.a., first law of the thermodynamics). It do not belong to the classic thermodynamics since is expunging the ENTROPY. EVIDENTLY, THE NEW COMBINATION OF THE ENERGY CONSERVATION LAW WITH THE RECTIFICATION creates A NEW SCIENCE NAMED BEZENTROPIC THERMOMECHANICS, because: the energy. of the HIDDEN (INTERNAL) molecular vibration—before the rectification—is NOT HEAT; it is KINETIC ENERGY LIKE THE TANGIBLE ENERGY AFTER THE MOLECULAR RECTIFICATION. This is why the THERMOMECHANICS ARE 99% efficient.

That way the NOZZLE of LAVAL CREATES REMARKABLE SUPERSONIC JET, BLOWING THE BEZENTROPIC TURBINE'S ROTOR TO PRODUCE WORK. In contrast with this, inside the classic engine or turbine, the work is obtained by DISORDERED MOLECULAR EXPANSION CAUSED AGAIN BY THE HEAT, BUT WITHOUT PRELIMINARY MOLECULAR RECTIFICATION. Due to such EXPANSION less than ⅓ of the molecules are actually pushing the pistons to obtain work. The remained ⅔ heat is unavailable for conversion to work and is exhausted as ENTROPIC LOSSES. This is why the STIMULATED SPONTANEOUS MOLECULAR. RECTIFICATION of the BEZENTROPIC THERMOMECHANICS are much more efficient than the DISORDERED VOLUME EXPANSION.

All of above is well visible from FIG. 5(a,b) representing a working diagram of a nozzle of Laval, from MAX PLANK's INSTITUTE and by comparing the following efficiency formulae of the CYCLE of CARNOT and of the BEZENTROPIC. TURBINES:

η=(T₂−T₁)/T₂·100% (Carnot cycle) 22.

η=(W₂²−W₁²)/W₂²·100% (the Bezentropic turbine and nozzle of Laval) 23.

The efficiency difference between the cycle of Carnot and the Bezentropic turbine is enormous because, while the absolute temperatures T (in the classic formula 22) is elevated on first power, that of the velocities W of the bezentropic turbines' efficiency (formula 23) are elevated on second power. This difference allows near 100% efficiency of the nozzle of Laval. This fat is well evidenced by the experimental results displayed by FIG. 5.(b) where W₁≈0 yielding W₁²≈0 and leading to

η=W₂²/W₂²·100%=100% 24.

The same diagram displays that the temperature of the steam at the input of. the nozzle is 400° C. This creates negligible heat losses, from radiation, in the order of only 005% to 1%. On the other hand, the static pressure at the same input is 30 ata and it drops down to less than 1.5 ata because, section II of the nozzle, converts it to DYNAMIC PRESSURE which TANTAMOUNT to LINEAR KINETIC ENERGY Eₖ=mW².

Accordingly, due to same conversion, the initial temperature of 400° C. drops down to about 60° C. at the output of the nozzle. Contrary to that, the initially inputted volume of steam of 0.04 units (at said pressure of 30 ata and temperature of 400° C.) increases to 0.95 or more than 18 times. This is absolutely impossible to be achieved by any pistons type engine, or by classic turbine. As stated, the nozzle of Laval does not convert, but only RECTIFIES the internal energy of the working body, since that energy is actually vibrating in all directions kinetic energy of the molecules. As a result, the rectification does not change neither the value of the entalpy (the heat content of the working body). nor, its KINETIC NATURE. It rectifies only that vibrating kinetic energy into JET of colinear kinetic energy. This is why the nozzle of Laval is so efficient BEZENTROPIC DEVICE.

### Improved Understanding and Definition of the Heat

The more precise definition of the heat energy, Eₕ, is the quantum definition provided by MAX PLANK, where THE HEAT ENERGY is represented as sum of energy particles (quanta) series of elementary quanta (elementary particles) ‘h’ Plank given by the equation:

Eₕ=h·υ 25.

where υ=frequency of the heat wave

These quanta (also named photons) are actually dynamic particles of kinetic heat energy which never stop to move since have NO MASS OF REST. They however have dynamic (kinetic) mass mₖ equal to

mₖ=(Eₕ/C²)^{1/2}=(h·υ/C²)^{1/2} and also impulse P=mₖ·C caused by its kinetic mass and velocity. 26.

Consequently, the energy of the photons is always only kinetic energy. They could never be converted to potential form of energy for they have no mass at rest. On the other hand since they strictly respect the law of energy conservation, it is wrong to believe and state that they are “absorbed” and “emitted” by the electrons and the black bodies. In the view of this inventor, and his theory of the Bezentropy, the PHOTONS are actually SATELLIZED and DESATELIZED around the electrons of the matter. Physically, this satellization happens in accordance with the (previously discovered by inventor) ELEMENTARY FIELD of VALENCY around each photon. The heat caused by the adiabatic compression, the heat of the combustion, as well as, any other form of heat (indicated by the thermometers) constitutes therefore clouds of FREE photons, desatellized from the electrons by the collisions between the atoms and the molecules, demself exited by the bouncing photons. What we and the thermometers are sensing as “heat” therefor is not the disordered molecular bouncing, but the FREE PHOTONS liberated by the bouncings.

The heat inflates the volumes of the gases and steam because the photons colliding with the molecules increase their vibrations and ‘median free path’ of the vibrating molecules, thus expanding their volumes. The less productive HEAT TO WORK CONVERSION of the classic thermodynamics is using namely that property of the heat since no one had idea of the more advantageous BESENTROPIC GENERATION OF WORK.

### What Jet Velocity is Needed for Full Rectification Of the Molecular Disorder into Order?

There are two answers: (1) SUPERSONIC VELOCITY and NOZZLE of LAVAL or, the FLAT (OVAL) NOZZLE of this inventor ARE NEEDED when the HEAT is converted to KINETIC ENERGY. The value of the supersonic velocity is this, at which the ENTALPY of the saturated water steam is RECTIFIED and fully converted into linear KINETIC ENERGY given by the equations:

j(kcal/Kg)=A·W²/₂ 27.

where J is taken from the professional steam tables. At pressure of 30 ata it is 669.7≈670 Kcal/Kg and yields

W(M/sec)=(2j/A)^{1/2}=(1340.427)^{1/2}=756.4 Meters/sec. 28.

At pressure of 20 ata, j=668.5 and in these conditions we have

W=(2.668,5.427)^{1/2}=(1337.427)^{1/2}=(570 899)^{1/2}=755.6 M/sec 29.

or, almost the same critical supersonic velocity.

(2) In cases (like PARADOX No 3) when the heat is converted SLOWLY TO POTENTIAL ENERGY, where the RECTIFICATION relies on the combined effect of the ‘latent heat of vaporization’ ‘r’ and the law of Archimedes RELEVANT IS NOT THE VELOCITY of the molecules but, the ALTITUDE ‘h’ of the ELEVATION. Due to this, the formula of the ELEVATION at which the ENTALPY becomes fully converted to POTENTIAL ENERGY is:

h=r/A=r.427 30.

HOWEVER, the real altitude always differs from this calculated by formula 30 because: in accordance with the quantum mechanics, there is emission of thermal photons, without temperature gradient, and at zero divergence. Consequently, notwithstanding the practically adiabatic elevation of the vapor up to the clouds, the elevated vapor becomes colder and colder during its elevation. This significantly shortens the altitude calculated by formula 30. On the other hands, the daily fluctuations of the atmospheric temperature and pressure makes formula 30 further unuseable. Consequently, the correct answer concerning the CRITICAL ALTITUDE of phase transformation of the vapor. into cloud fog, is the DAILY ALTITUDE of the CLOUDS.

In the above conditions, the practical approach for defining the approximate critical altitude of the freon “h_{Fr}”, at which the entire ‘latent heat of vaporization’ of the FREON MUST BE CONVERTED (by freon RAIN in closed circuit) to POTENTIAL ENERGY, defined as follows:

h_{Fr}=h_{c·}r_{Fr}/r_{w}; 31.

where: h_{c}=average clouds' altitude=2000 Meters; r_{Fr}=latent heat of vaporization of the freon; and r_{w}=latent heat of the water vapor;

### EXAMPLE

h_{Fr}=2000.30/540=111,(1) 32

Meters, or less than ⅓ from the Eiffel tower.

WHEREAS all vapor molecule during the kinetic elevation are rectified and VERTICALLY DIRECTED by the ARCHIMEDES PRINCIPLE and the so obtained potential energy—of the so created clouds are both mechanical form of energies, the stated change is again kind of BEZENTROPIC RECTIFICATION plus CONVERSION because, is again EXPUNGING THE ENTROPY and occurring without loss of energy.

The NOZZLE of LAVAL was invented more than one century ago but, no one before this invention noticed that it is a BEACON, GUIDING TO THE NEW THERMOMECHANICS. The cause of this delay is the fact that the nozzle of Laval is neither an engine, nor a turbine. It is only a DEVICE, not useful alone, nor. is effective in combination with the classic turbines.

### Example 1

when a nozzle of Laval is used for JET PROPULSION PURPOSE, it exhausts in the atmosphere a lot of unused linear kinetic energy, making the JET PROPULSION (at low altitudes) less efficient than the piston engines. This gives a false impression that it is subjected to the classic thermodynamics an to the entropy.

### Example 2

when Laval's nozzle is used to rotate a classic turbine, its efficiency effect is weak. This again gives the false impression that the said nozzle is subjected to the law of entropy and the classic thermodynamics. INDEED, the causes for that poor result are the several thousands blades of the classic turbines; which instantaneously convert the COLINEAR MOLECULAR ORDER, OF NOZZLE'S JET, into MOLECULAR DISORDER; THUS, INVOKING the LAW OF THE ENTROPY and THE CLASSIC THERMODYNAMICS.

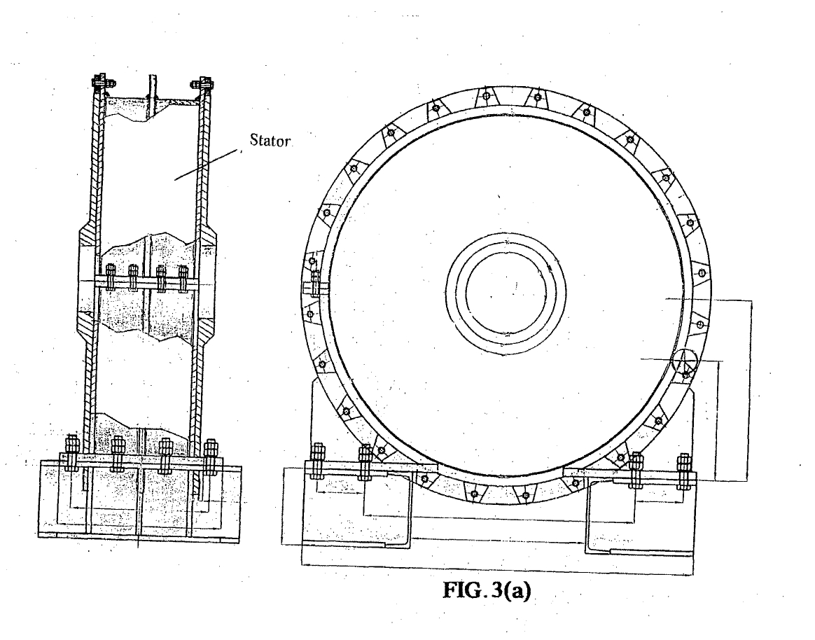

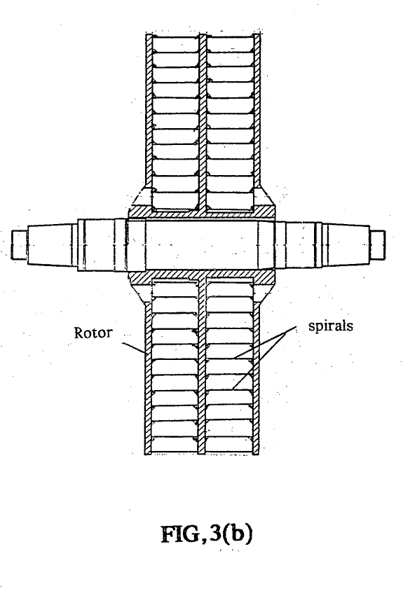

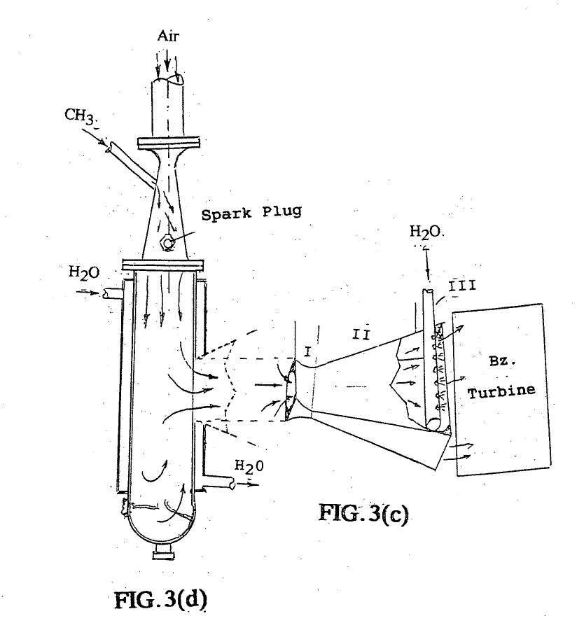

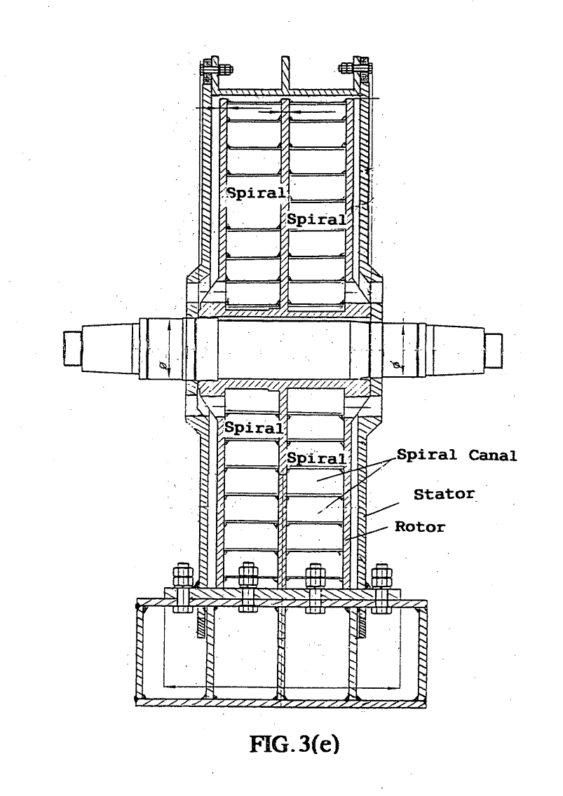

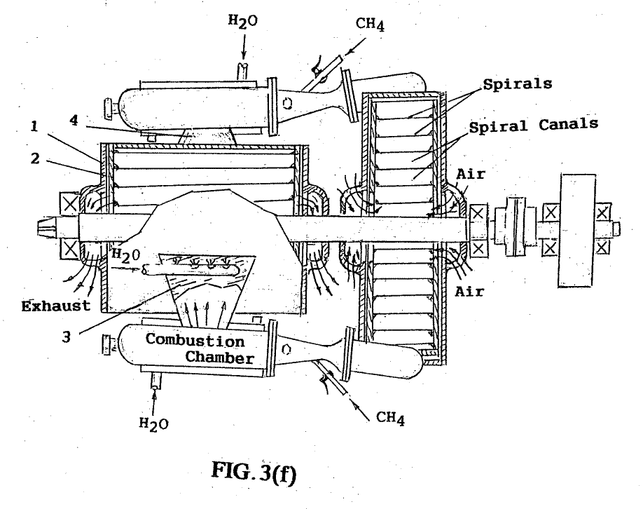

Once understanding the problem, the inventor began immediately to search for turbines without turbine blades. This way were invented the first in the world (and in science and technology) the BLADELESS BEZENTROPIC TURBINES’: BLADELESS STATOR shown on FIG. 3(a); ROTOR of FIG. 3(b); the new triple accelerating flat nozzle of FIG. 3(c); the combustion chambers of FIG. 3(d); and the bladeless TURBO COMPRESSOR of FIG. 3(e); all serving as main parts of the BEZENTROPIC TURBINE shown on FIG. 3(f).

Quite naturally such a turbine can be easily modified to work, beside as gasturbine, also as UNIVERSAL STEAM TURBINE using CLASSIC, NUCLEAR, or, FREON BOILERS, thus, abandoning the combustion chambers.

As seen by FIG. 3(a), the BEZENTROPIC STATOR has no turbine BLADES. It represents an empty horizontal cylinder whose purpose is to house the ROTOR of FIG. 3(b). Upon that stator are fixated the two opposing—at 180°—the triple accelerating flat nozzles 3 an 4 of FIG. 3(f) shown separately also on FIG. 3(c,d). The said 2 nozzles are fed with pressured combusted gases from the two COMBUSTION CHAMBERS 5 and 6 connected to the nozzles shown on FIG. 3(f) and separately on FIG. 3(d). The ROTOR (like the STATOR) is also BLADELESS, made that way to avoid the destruction of the COLINEAR MOLECULAR ORDER of the SUPERSONIC JETS—coming from said nozzles 3 and 4. The roles of the nozzles is to accelerate the JETS to supersonic velocity, thereby to RECTIFY the molecular DISORDER (coming from the combustion chambers). The role of the ROTOR is to keep the obtained order until the full conversion of that LINEAR KINETIC ENERGY into SPIRAL CIRCULAR KINETIC ENERGY, which tantamounts to MECHANICAL WORK. In order to attain this task perfectly, the thousands blades of the classic rotors are now replaced only by two (2) OPPOSING—EVOLVING—SPIRALS, creating 2 OPPOSING SPIRAL CHANNELS. The roles of the evolving channels is to conserve the molecular order of the Jets by converting them, and their kinetic energy, from linear into spiral, until the full conversion of that kinetic energy to work. For this purpose, the nozzles JETS blow their kinetic energy tangential to rotor's spiral channels, while the exhausted working body (gas+steam) is exhausted centrally, through the circular series of apertures made around the sides of turbine's shaft. The Inventor's flat nozzles given on FIG. 3(c) consist of 3 main parts: I, II, and III and work as follows: like in the nozzle of LAVAL, Part I is convergent and Part II is divergent, (of the same 7° to 12° angular degrees) to allow supersonic velocity acceleration like in the nozzle of Laval. Now however, the CROSS SECTIONS of parts I and II are not circular but, are flattened to ovals, to better correspond to rotor's spiral channels' cross sections where the JETS must blow theirs—supersonic accelerated—working body. Up to here however, the flattened nozzle is. expected to be a little bit less efficient than the round nozzle of Laval. Consequently, to avoid such inconvenience, the inventor introduced a third mode of acceleration performed by the dead ended tube III fixed parallel to the output of the nozzle and perforated along its length by a series of tinny holes. The role of said perforation is to sprinkle preheated water taken from the combustion chambers. Once sprinkled, that water spontaneously flashes into preheated steam, increasing its volume to more than 1600 times which additionally accelerates the velocity of the JETS to more than 4 times of the sound.

FIG. 3(e) represents the turbo compressor of the BEZENTROPIC TURBINE. Essentially, its construction is the same as that of the turbine's rotor and stator, except that its diameter size is larger, and that instead of having combustion chambers, it is connected—through 2 wide tubes—to 2 nozzles of Laval, themselves connected to the 2 combustion chambers. The roles of said 2 nozzles of Laval, is not to rectify the internally vibrating kinetic energy of the molecules, but, to create strong dynamic pressure thus, to act as check waive counteracting the static. pressure inside the combustion chambers and thereby to insure uninterrupted burned gas flow needed to the ‘triple accelerating nozzles’, of this inventor, having the task to RECTIFY the internally vibrating kinetic energy of the molecules inside the combustion chambers.

### Cryogenic (Freon) Type Bezentropic Turbine

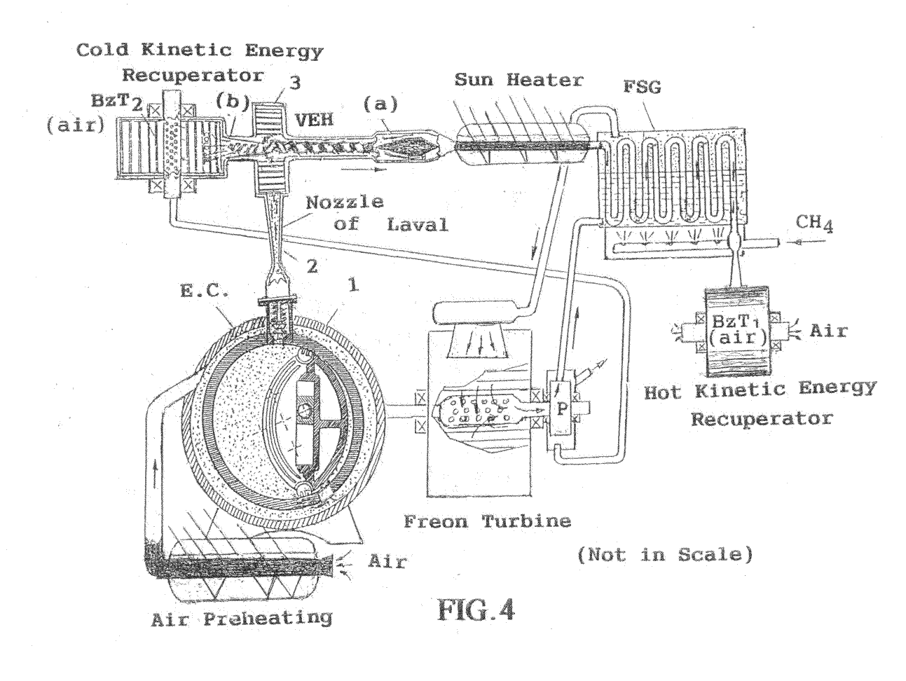

It is displayed on FIG. 4. The construction of its STATOR and ROTOR is the same as these of the previously disclosed turbine. The difference is that the cryogenic turbine has no combustion chambers, neither turbo compressor. Instead, it is equipped with one FREON STEAM GENERATOR (FSG), one ELLIPTIC COMPRESSOR (EC) and one VORTEX COOLER AND HEATER (VCH), all, except the VCH, working inside FREON CLOSED CIRCUIT as shown on FIG. 4. The turbine works in the following manner:

The FSG needs very little heating for 2 reasons:

(1) the new eco freons have boiling temperature in the order of −48° C. to −50° For that reason, a temperature of only+50° C. to +10° C. is large enough to produce the desired pressure of 20 to 30 atmospheres preheated freon steam and,

(2) the VORTEX TUBE of the VCH is. capable of providing at least half of the necessary heat, taken from the ambient atmospheric air. The VORTEX TUBE does this by separating air's molecules of high velocity—having high temperature—from the molecules of lower velocity and low energy. This way, the inventor obtained (from ambient temperature of 20° C.) a temperature of 130° C. at the hot end of the vortex tube, and—40° C. at the cold end of the same vortex tube.

The vortex tube was discovered accidentally in 1928, by the French physicist GEORGE RANQUE, but, no one until the present time has noticed that it is a BEZENTROPIC DEVICE. To some extent it was foreseen (or more properly was day dreamed) by JAMES CLARK MAXWELL (in the 19 century) as follows:

“Since heat involve the movement of molecules, we might someday be able to get hot and cold air from the same device with the help of a “little friendly demon” who would sort out and separate the hot and the cold molecules of the air”

The main principle of the vortex. tube is creating a tubular construction housing two (2) simultaneous opposing concentric vertical air flows (one inner and another one enveloping the first one. The opposing spiral molecular rotations and propagation usually attains more than 1 million revolutions' per minute; then, in these conditions, the inner vortex flow transfer its photons to the enveloping it and moving in opposing direction vortex air flow. In this manner—at the opposing ends of the vortex tube—sorting and separation of the hot and the cold molecule of the air is obtained. Quite obviously, it is in this manner that the job of MAXWELL'S “little friendly demon” is conducted.

The necessary working pressure for the vortex tube is 4 to 8 atmospheres. That pressure is led, tangential—by the nozzle 2—into the spiral camera 4 of the vortex tube situated between the cold and the hot parts of the tube as shown on FIG. 4. The orifice Of the camera toward the cold end of the tube is made purposely smaller than the opposite orifice. In this way, all original air flow is first directed to the hot end of the tube and opposing vortex flow is obtained by reflecting part of the original flow, through the small conical device fixed at the hot end (a) of the tube.

Obviously, the vortex tube could be used like a HEAT PUMP for air conditioning and other purposes. GEORGE RANQUE tried to commercialize it, but without success and about 2 years later, abandoned it. As shown by FIG. 4 and FIG. 7 this inventor improved its efficiency as follows:

(a) by adding the more efficient ELLIPTIC COMPRESSOR 1,

(b) by added the nozzle of Laval 2 to increase molecular velocity, and

(c) by adding his original ‘still spiral camera (chamber) 3’ to increase the vortex
velocities to the opposing vortex flows and thus to create better conditions for said molecular sorting and separation.

The vortex tube is both adiabatic and bezentropic device because: it is ADIABATIC for its high velocity bars heat exchange with the environment, and is BEZENTROPIC for it only SORTING the molecules having higher temperature from these having lower temperature and RECTIFYING the disordered molecular thermal vibration into opposing circular ORDER respecting the energy conservation law and expunging the ENTROPY.

### The Elliptic Compressors and Engines

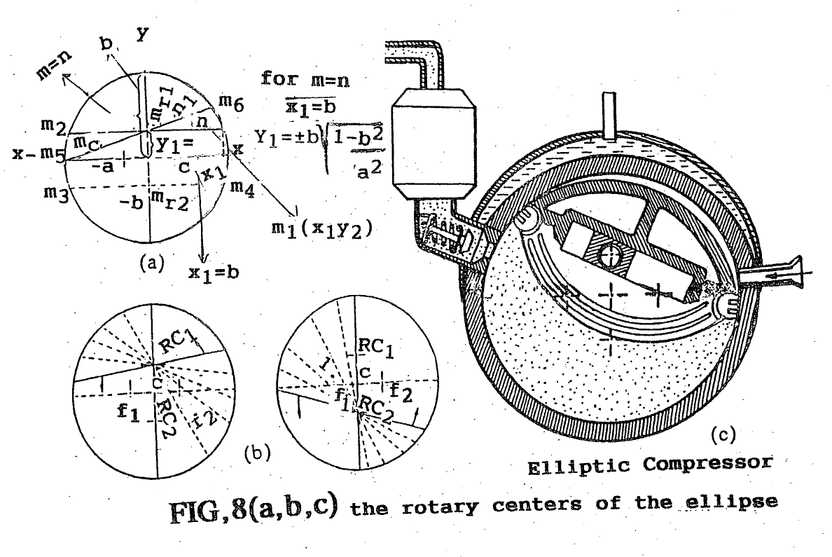

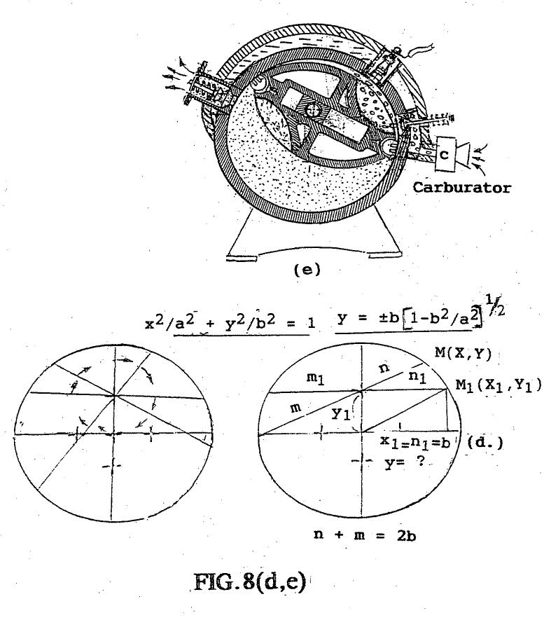

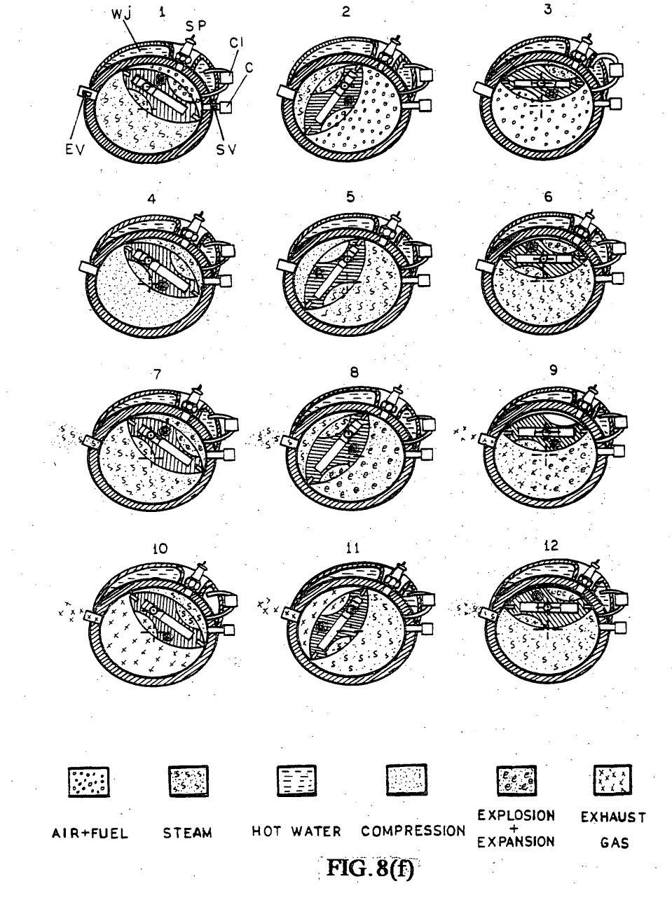

They both are based on the unique discovery of this inventor that beside all known elements of the ellipse (described by EUCLID more than 2500 years ago) in each ellipse exist also 2 rotary centers having the remarkable property: “any chord equal to the small diameter of the ellipse can be rotated around each of said 2 rotary centers as conveniently as one can rotate the diameter of a circumference around its center”. It is geometrically explained on FIG. 8(a) where the formulae of calculating the X, Y coordinates of Said ROTARY CENTERS are given. FIG. 8. (b) and FIG. 8. (c) display how one can use the rotary centers to build an elliptic compressor. FIG. 8(d), FIG. 8(e) and FIG. 8(f) show how one can use the rotary centers of the ellipse to build a more advantageous ELLIPTIC ROTARY ENGINE.

### Advantages of the Elliptic System

Due to its unique rotary centers, the elliptic system of compressors provides better conditions for tightening, balance, volume pressure and power in comparison with all other rotary compressors. When compared with WANKEL'S TROCHOIDAL SYSTEM, the advantages are: (1) absence of dead volume; (2) absence of the insight (1:3) gearing; (3) same RPM of the ROTOR and Its SHAFT; better tightening and higher pressure.

### The Bezentropic Starting Engine of the Turbine

Differently from the steam turbines, any gas turbine needs STARTING ENGINES or small steam turbines, or, electric motor to start working. However, neither of them is best choice for they all are of low efficiency and cannot contribute to the efficiency of a BEZENTROPIC TURBINE. at peek power hours when supplemental power could be added from the starting engine. The best solution in such cases therefore would be to Invent a BEZENTROPIC STARTING ENGINE—NOT SUBJECTED TO THE LAW OF ENTROPY— permitting to be used not only as starting engine, but, also capable to provide supplemental power during the peek hours of electricity consumption. In this case ‘not subjected to the law of entropy’ means engine having capability of directly integrating the NATURAL TOTAL DIFFERENTIAL OF THE ENTALPY, given by equation (L), the other total energy differentials given by equations (m), (n), (O), (p) and before all equation (g).

Such capability is missing in all classic engines and turbines; hence it sounds as enigma never noticed by the science. This enigma was noticed and solved by this inventor. It allowed him to formulate the bezentropic thermomechanics, engines, turbines and other devices. Looking at formula (g) the inventor noticed that:

(1) the short length of the cylinders in all classic engines unavoidably cuts the possibility for obtaining the better kinetic and potential energy from the working body (gas or steam);

(2) the dead points of the reciprocating engines' pistons are also suppressing the kinetic energy and cutting the expression ‘+vdP’; thus, converting the ENTALPY (the heat content) to the less productive PARTIAL That is because, at W=0 v=Const. and dP=0; thus, making vdP=0 which converts the TOTAL (full) DIFFERENTIAL EQUATION (g), of the entalpy, into PARTIAL DIFFERENTIAL EQUATION; which cannot be integrated directly. To integrate it one must convert it to the ARTIFICIAL TOTAL DIFFERENTIAL (h) or (i) of the ENTROPY, which INVOKES ENTROPIC LOSES. In the mean time all that increases the molecular disorder of the working body.

(3) The poor efficiency performance of the classic turbines is due to the thousands turbine blades fixed upon the turbine's rotor and stator, imitating the pistons of the reciprocating. classic engines. They cause even more molecular disorder in the working body, completely destroying the molecular order initially caused there by the Nozzles of Laval; all the while converting the natural total differentials of the Entalpy into the less productive PARTIAL. ENERGY DIFFERENTIAL. Analyzing the above situation the inventor concluded that:

(1). If one desires to build a turbines having better efficiency than the classic turbine, only BLADELESS TURBINES must be built, as these already above disclosed and

(2). If one desires to build PISTON ENGINES having better efficiency than anyone of the classic piston. engines, then he must build ENGINES WITHOUT RECIPROCATING PISTONS capable of direct integration of the natural total differentials of the ENTALPY and to perform the new thermodynamic cycles of this inventor. Such piston engines are the TOROIDAL ROTARY PISTON ENGINE

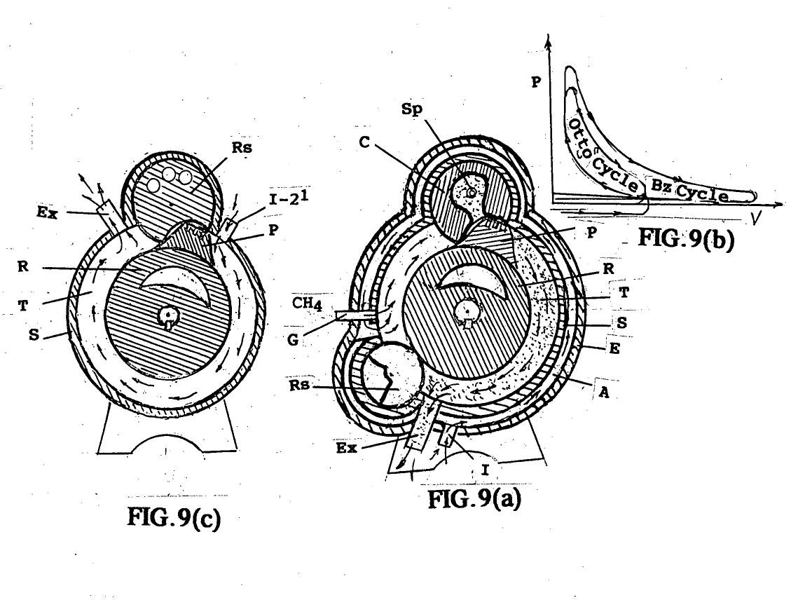

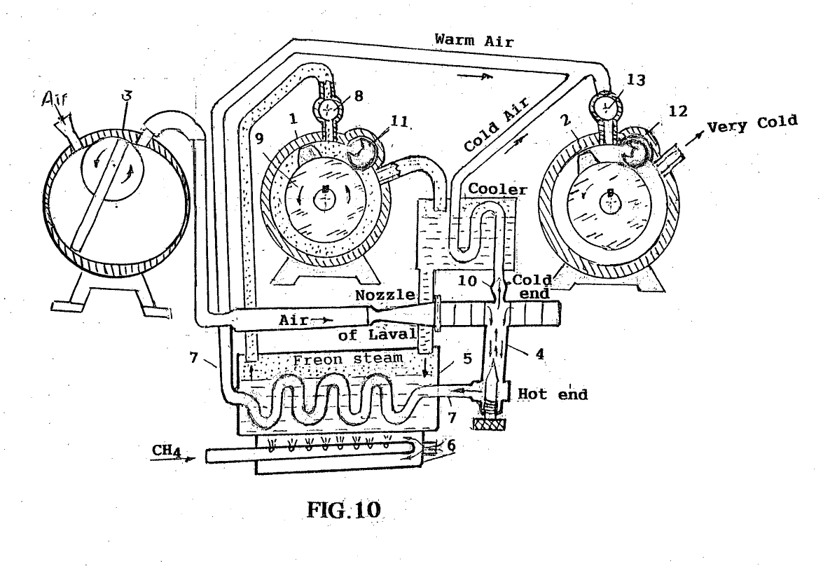

shown on FIG. 9(a, b, c) used as starting engine of the BEZENTROPIC TURBINE and also on FIG. 10.

It consists of one—or more—main toroidal engine as shown on FIG. 9(a) performing the bezentropic cycle of FIG. 9(b) and one—or more—supplemental simplified toroidal engine of FIG. 9(c) connected to the main engine having the role of converting to work the remained kinetic energy of the rotation as well. The toroidal working volumes of both engines is indicated by the letter ‘T’; their rotors are noted by the letter ‘R’. The rotors are housed by their stators ‘S’. The stator of the main engine shown on FIG. 9(a) has also an envelop noted by the letter ‘E’ whose purpose is to create the air channel ‘A’ of the air cooling of the engine, performing at the same time the desired regeneration of the radiated heat by inputting it back in the working cycle of FIG. 9(a). Each of the rotors has only one rotary piston noted by the letter ‘P’. That of the main engine is synchronized with its chamber of combustion ‘C’ which also plays the role of a rotating valve. The main engines uses also the rotary separator Rs. The air input of the main engine is noted by ‘I’ and the gas input is noted by the letter G. It can be either natural gas or carburetor for liquid fuel. The input ‘I-2’ of the supplemental engine serves to admit the exhausted working body of the main engine in order to recuperate the remained kinetic energy exhausted by the main engine. The exhausts in both engines is

‘Ex’. The spark plug ‘Sp’ is fixed in the center of the rotating combustion chamber. The engine has also 12 volts battery and starter and ignition key not shown on the drawing. Not shown also is the CLUTCH connecting the starting engine with the turbine. The rotor and the rotating combustion chamber are synchronized in 1:1 ratio and the curbs of the piston and camera are parts of special cycloides. The so described TOROIDAL BEZENTROPIC ENGINE works as follows:

the engine is put in rotating mode with the help of the ignition key. This causes the engine to suck pure air through the input ‘I’ and gas and air blend through the G. That gas mixture is compressed by the piston ‘P’ and transferred in the rotating combustion chamber ‘C’ which also plays the role of separating, the compression from the working volume of the engine. The spark plug ‘Sp’ ignites the compressed combustion mixture and the obtained high pressure pushes the piston P causing the engine to work. As seen from FIG. 9(a) the volume of the gas expansion ‘Ve’ is 3 times as large as the volume of the sucking and compression ‘Vc’. Precisely this creates the new thermodynamic cycle of this inventor, shown on FIG. 9(b). Moreover, because the rotary piston has no “death points”, the process of the expansion also creates significant rotary kinetic energy and safeguards the term of the entalpy+VdP and from there the entire ENTALPY, which like the kinetic energy is a NATURAL TOTAL DIFFERENTIAL, CONVERTIBLE DIRECTLY TO WORK. Because of that, the new thermodynamic cycle of the inventor is BEZENTROPIC Consequently, the new engine of FIG. 9(a) is also bezentropic for it is capable of DIRECTLY INTEGRATING and CONVERTING THE ENTIRE HEAT CONTENT (ENTALPY) OF THE WORKING BODY INTO WORK. The role of the second toroidal engine of FIG. 9(c) has evidently a limited role: to recuperate the created kinetic energy. However, it can be efficiently used also as an independent bezentropic steam, or, freon steam engine.

### Super Cryogenic Toroidal. Engine

It is shown on FIG. 10 and represents a combination comprising: an ENGINE OF TOROIDAL CONSTRICTION having 2 toroidal working volumes (1 and 2) combined with the ELLIPTIC COMPRESSOR 3, the VORTEX TUBE 4, and the FREON BOILER 5 having both a GAS HEATER. 6 and HOT AIR HEATING coming from the hot end of VORTEX TUBE 4 THROUGH the SERPENTINE 7. A vortex tube has no moving parts but when supplied with pressured air of 4 to 8, or more, atmospheres always SPONTANEOUSLY generates hot air at its hot end and cold air at its cold end. In this particular case, the necessary. pressured air, for the vortex tube 4, comes from the elliptic compressor 3 via the nozzle of Laval. The first toroid 1 has a Rotary VALVE 8 having the task of allowing periodical INPUT of freon steam only till the volume LIMIT 9 (around ¼ to ⅓ from the total toroidal volume), reserving the rest for the FULL EXPANSION of that steam. This purpose is helped also by the rotary SEPARATOR 11 of the engine 1. The TOROID (engine) 2 IS OF THE SAME CONSTRUCTION. Its rotary separator is 12 and 13 is its rotary VALVE; however it does not work by freon steam but, trough the significant KINETIC ENERGY of the AIR, exhausted both from the COLD END 10 of the VORTEX TUBE and that of the less cold end of the serpentine 7.

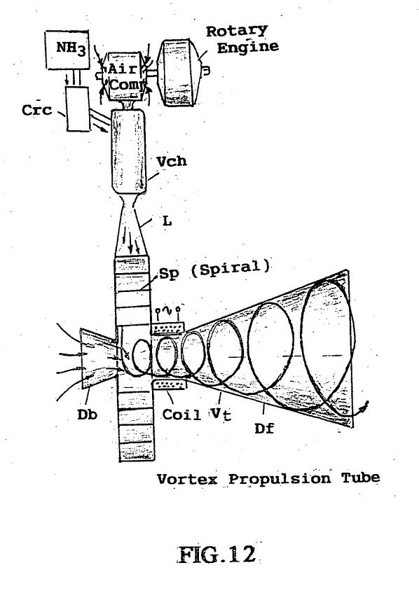

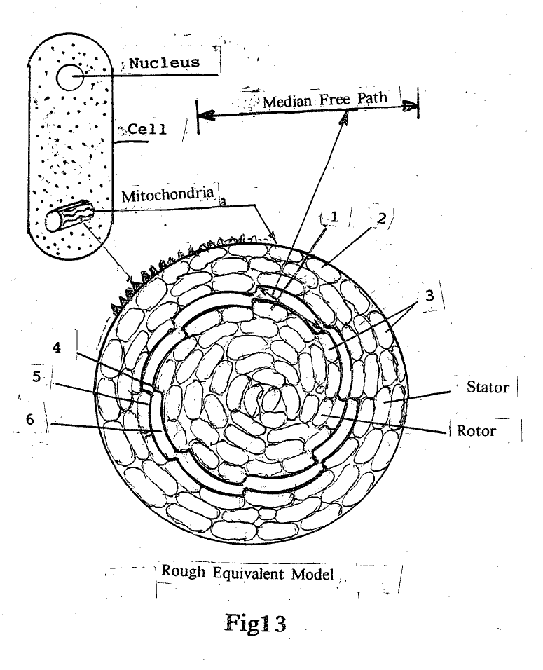

The merit of such combination is that if can use very little fuel, for it derives most of its energy FROM THE ATMOSPHERIC AIR WHICH IS SUN ENERGY CAPTURED WITHOUT THE EXPENSIVE MIRRORS, SOLAR SEMI CONDUCTORS, CATALYSTS AND TERRAIN LARGER THAN POLAND TO SATISFY ONLY EUROPE, SHOULD THE EUROPEANS DECIDE TO USE ONLY SUN ENERGY. MOREOVER, THE TURBINE OF FIG. 12 MAY WELL WORK ONLY THROUGH SUN ENERGY TAKEN FROM THE AIR BECAUSE OF THE FOLLOWING: a VORTEX TUBE works like a HEAT PUMP but, is SUPERIOR to any classic heat pump (widely used for air condition purpose). That is because, the classic heat pumps having the efficiency of the REVERSE THERMODYNAMIC CYCLES OF THOMSON,

T₂/(T₂−T₁) 33.

are obviously efficient only for small temperature differences, (attaining practically no more than 130% efficiency). Such limit do not exists. for any VORTEX TUBE for it is a ‘bezentropic adiabatic devise’ not following the classic thermodynamics' processes. It only separates the HOT from the COLD air molecules into 2 separate streams; then, allowing—as needed—to fully convert them: TO WORK, HEAT (of HIGHER temperature) or to COLD (of much COLDER temperature), eliminating fully the energy losses associated with the entropy.

Because of all above said, the energy efficiency of the vortex tube—used as heat pump—is. (theoretically) unlimited and practically can attain even more than 200%. Let's assume that for the time being we are not perfect bezentropic masters and that we can build only 150% efficient vortex pump and only 80% efficient bezentropic freon engines, using the new

freons as the working body and atmospheric air for the vortex tube. Let's assume that by rotating the elliptic compressor—we are inputting the equivalent of 100 Kcal heat In said vortex tube. As the result, the vortex tube having efficiency of 180% (like the classic heat pump) would extract extra heat from the atmospheric air and will add it to the original 100 Kcals increasing that amount to 180 Kcals. Let's then convert said 180 Kcals to mechanical work with the freon using toroidal bezentropic of 80% efficiency. Evidently, the GAIN would be:

180 Kcals×80%=140Kcals 34.

work and the net energy extracted from the atmospheric air would be: 140 Kcals−100 Kcls=40 Kcals after returning the cost of the initial 100 Kcals.
This is actually infinite efficiency for that is free energy at zero cost, obtained for seconds.

Such combination mounted on a car eventually may need some fuel in the winter time, but, (one day) after more besentropic Improvements, fuel will not be needed even in winter time. Remember that the allowed ecological freons boil at −48° C. to −50° C., meaning that at even ZERO, TEMPERATURE the fren steam is still preheated and produces atmospheric pressure in the order of 15 to 20 atmospheres. Such combination is not possible with the classic engine and vortex. tube, because, even the best DIESEL ENGINES have efficiency of no more than 40%. So far, the bezentropy once again defies the limitations of the classic thermodynamics and the entropy allowing the extraction of FREE ENERGY from one only large reservoir of heat, like the atmospheric air. That is STRICTLY BARRED by the entropy, but, not by the bezentropy. So vive la bezentropyl The next freon turbine variant displays similar success!!

### Hydraulic Bezentropic Turbine by Freonfall

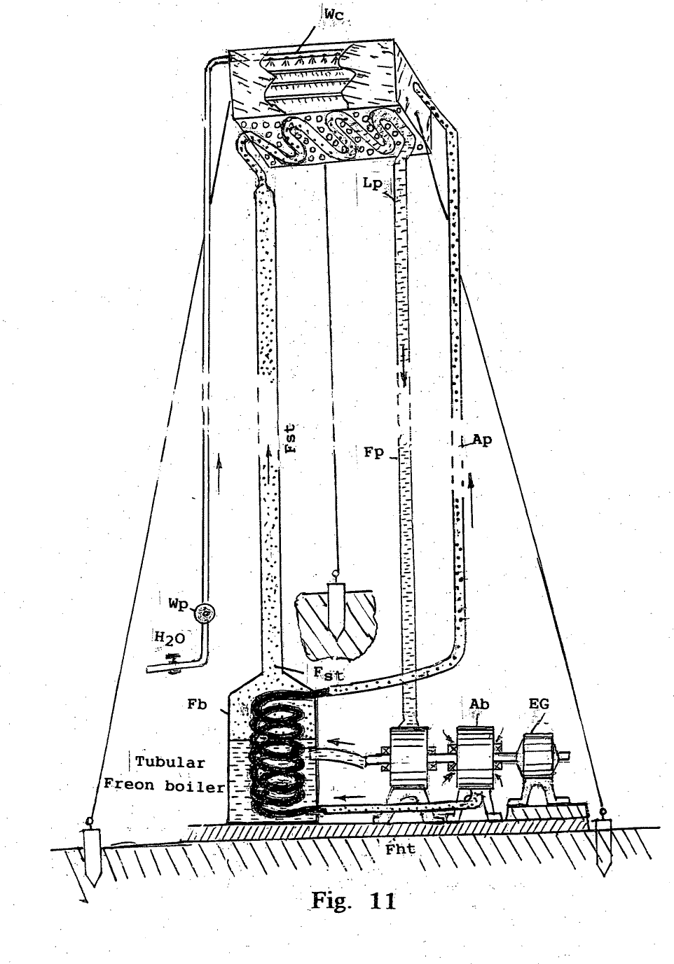

The capability of the freon steam to create FREON RAIN and FREONFALLS (at acceptable. ALTITUDE) for practical purposes, like for example for freon type hydraulic power plants, was already discussed related to formulae 31 and 32. Such a power plant is now illustrated by FIG. 11 where: Fb is a freon boiler heated by compressed atmospheric air coming from the AIR BLOWER Ab. The obtained freon steam Fst elevates up to the Wc where it condenses, because: due to the elevation the freon steam condense and converts its latent heat of vaporization to the potential energy of the so obtained freon rain and freonfalls. There the water cooler Wc is optional and serves to speed the condensation. It is supplied by water trough the water pipe Wp, and with air through the air pipe Ap. The so condensed freon creates a strong FREON FALL rotating the freon hydraulic turbine Fht (through the freon pipe Fp) thus, rotating both the air blower Ab and the electric generator EG. The construction of the FREON HYDRAULIC TURBINE is similar to the previously described bladeless bezentropic turbines. Like the waterfall hydraulic turbines, it works without fuel because, as primary source of energy it uses the LATENT HEAT OF FREON'S VAPORIZATION, obtained by heat from the atmospheric air, coming from the air blower Ab. There is full similarity between the formation of the processes of the vaporization, the condensation, rains waterfalls of the water and the freon. However, the artificial, FREONFALL is about 18 times quickly created that the natural WATERFALLS, because its LATENT HEAT OF VAPORIZATION is only in the order 32 Kcal/kg, while that of the water (both at ambient temperature) is 600 Kcals/kg. This means that the freon would make roughly 18 more cycles of evaporation, condensation and freonfalls at ambient temperature than the water at its boiling temperature of 100°. This is because, the allowed ecological freons boil in the temperature range of −48° C. to −50° C., while the water boils at 100° C. Namely, these parameters of the freons make them so attractive for the erection of Bezentropic electrical power plants.

### Vortex Propulsion Engine and its Ionic Fuel

A significant part of today air pollution is caused also by the aircraft engines using mostly the inefficient JET PROPULSION and fuels of polluting hydrocarbons.

To increase the efficiency of the propulsion and eliminate the polluting fuels in the aircraft transportation the inventor hereby proposes his superior VORTEX PROPULSION and his INEXPENSIVE IONIC, ZERO POLLUTION FUEL.

The vortex propulsion shown on FIG. 12 represents a modified vortex tube Vt consisting in a forward divergent part (cone) Df and a backward divergent conical part Db, both inter connected trough the spiral chamber Sp. The modification is made to abandon the original purpose of the vortex tubes (to separate the hot from the cold molecule) and instead of it to cause:

(1) sucking more air from Db; (2) to create a strong vortex fluid trust starting with the nozzle of Laval and the rotation inside the spiral Sp and then in the divergent part of the Df, where the strong vortex CENTRIFUGAL BULK FORCE is directly delivered on the conical surface of the Df. attaining millions of rotations. This way most of the vortex energy of the rotating gases is captured before they leave the Df which is impossible to do it by classic jet propulsion tube exhausting most of its linear kinetic energy to push the aircraft against the atmospheric air, lacking a SOLID WALL for such purpose.

The start of the vortex propulsion is performed the BEZENTROPIC ENGINE Be which rotates the air compressor Ac, blowing its air in the chamber of combustion Chc. In the meantime, a measured amount of AMMONIA NH₃ is passed in the CRACKING CHAMBER CrC where it is cracked through ELECTRIC ARC or, by heat of over 600° C. INTO NITROGEN N₂ and ATOMIC HYDROGEN H⁺, staying in IONIC STATE for about 30 seconds; after which, it becomes recombined into H₂ During the said 30 seconds, the atomic hydrogen forms perfect IONIC FUEL, since the 30 seconds are enough to be used as such, for it is used “1N SITU”. The so generated ionic fuel and the N₂ are then passed in the vortex chamber Vch; then in the nozzle L and start rotating in the spiral Sp from where are passing in the vortex tube, acquiring further rotary acceleration by the rotary electromagnetic field caused by the coil. In the mean time, one (not shown) spark plug ignites the hydrogen with air coming from Db which deliver more energy in the Df. Using sufficient length and divergence of the Df causes practically total use of the ionic fuel for VORTEX PROPULSION. For this purpose, the vortex tube must be made out of TITANIUM, or, out of high temperature CERAMIC material.

### The Mitochondria as the Bezentropic Engines of Life

A rough idea of them is given on FIG. 13 and was discussed in relations with PARADOX No 1. Like all cells of the human body, the MITICHONDRIA are built by proteins and the proteins in turn are built by the alpha amino acids. The most important phenomenon of the mitochondria is their ability to convert directly the heat into work and bioelectricity without TEMPERATURE GRADIENT. In this respect, they clearly DEFY THE ENTROPY (a.k.a the SECOND LAW OF THE CLASSIC THERMODYNAMICS). For this reason, the mitichondria declare then self as BEZENTROPIC NANO ENGINES and GENERATORS OF BIO ELECTRICITY IN ALL LIVING BEINGS. The details of theirs construction and work fits the following EQUIVALENT ROUGH PICTURE of FIG. 15: detail 1 represents a ROTOR hosed in the STATOR 2. They. both are built out of amino acids nano cells 3, arranged in patterns creating the toothed rotor 1 and the corresponding toothed stator 2 allowing only unidirectional rotation. The rotor is suspended inside the stator through residual molecular forces and has no bearings and physical axis. The molecules of rotor's and the stator's teeth are arranged to create the elongated cavities 6 filed up with liquid cytoplasma. The energy which rotates the rotor comes from the BROWNIAN MOVEMENT of the molecules of the plasma. Due to the nano size of said elongated cavities, the Brownian movement is constrained to rotate the rotor inside the stator. It is resupplied by heat developed by the oxidation of the glucose with the oxygen delivered by the hemoglobin of the blood inside the grooves formed by the wrinkled (corrugated) membrane of the cylindrical shaped mitochondria. On the other hand, the amino acids having opposing amino and acidic radicals through its rotation induce upon the stator bio electricity which is collected by the neurons and used by our central neuron system to drive our muscles and conscience.

### The Bezentropic Wind Turbine

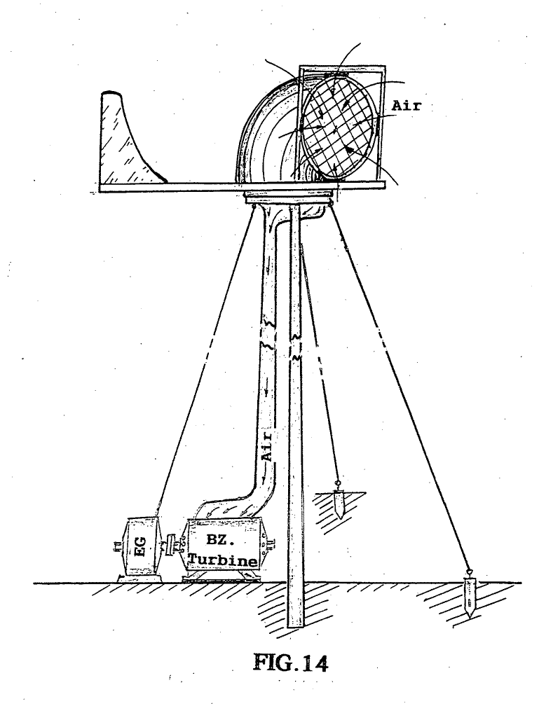

of FIG. 14 resembles the bezentropic steam turbine, as it essentially has the same construction of bladeless cylindrical stator housing a rotating reel like rotor, on which are wounded 2 or more spiral sheets forming 2 or more spiral channels, where wind is blown, captured. by an open to the wind extra large sac made from tissue and elevated on 50 to 100 meters by a pole from where that wind flow is piped down to the ground, again by a tissue made tube, where the wind turbine is placed, which turbine is easily convertible to wind powered power plant when is connected with a suitable electric generator.

### Bezentropic Manufacturing of Clean Fuel from Polluting Substance

In BLACK SEE, at debt of more than 150 meter, there is a lot of the very polluting HYDROGEN SULPHYDE gas dissolved in the see water. This gas however is potentially almost free fuel due to the following inexpensive BEZENTROPIC TECHNOLOGY can convert it to absolutely CLEAN FUEL plus valuable CLEAN BY-PRODUCTS without exhausting in the atmosphere or, in the see EVEN A SINGLE MOLECULE. FIG. 18 helps to explain that as follows: detail 1 is one wide polyethylene made hose, sucking see water with dissolved HYDROGEN SULPHIDE H₂S from deepness of more than 150 meters. Detail P represents a water pump pumping see water and storing it in the reservoir 2, installed on the see shore. Detail 3 is a special water submerged spark plug causing underwater electric explosions—by way of programmed short circuits. Such explosions liberates the H₂S gas from the water and it is directed to the FIRE PLACE 3 of the steam generator 4 supplying steam for the STEAM TURBINE of the BEZENTROPIC POWER PLANT 5. The H₂S is burned in FLUIDIZED BED—in the presence limestone CaCO₃— which combines with the sulphor S into the valuable and absolutely neutral GYPSUM. The inexpensive BEZENTROPIC ELECTRICITY is then used to produce CLEAN HYDROGEN FUEL THROUGH ELECTROLYSIS OF THE H₂O.

What I claim is:

1. THE PROCESS OF PROCESSES FOR RADICAL SOLUTION OF THE AIR POLLUTION AND THE GLOBAL WARMING BASED ON THE DISCOVERY OF THE BEZENTROPIC THERMOMECHANICS and other novelties comprising:
a plurality of BEZENTROPIC PROCESSES, DEVICES, TURBINES and ENGINES, invented by this inventor, allowing to generate—at unusual high efficiency and ZERO POLLUTION— very inexpensive electricity and HYDROGEN, via that electricity plus
another plurality, of mixed chemical and geophysical processes, permitting further to lower the price of electricity by producing for that purpose inexpensive ‘primary fuel’ for fueling the BEZENTROPIC ELECTRIC POWER PLANTS, claiming: (1) an original method for prospecting and mining METHANE HYDRATES—a.k.a. GAS HYDRATES— existing abundantly in the BLACK SEA and other seas and oceans and deriving from them LESS EXPENSIVE NATURAL GAS; (2) an original REDOX PROCESS involving the continuous compounding and recycling the inexpensive NaOH and MnO₂ done by direct sun energy and biomass and (3) the modified FUEL ALLOYS—previously patented by the same inventor—where the modification is performed to produce mainly SYNTHETIC METHANE—all again performed at ZERO POLLUTION, without exhausting in the atmosphere neither CO₂ nor any CARCINOGENS; where,
the main role of all above is based on inventor's BASIC DISCOVERY of the NEW UNIVERSAL LAW OF BEZENTROPY consisting of stimulated spontaneous RECTIFICATION of the MOLECULAR DISORDER into MOLECULAR ORDER of the GASES and the STEAM, NOT CHANGING THE MECHANICAL NATURE of the KINETIC ENERGY; hence, NOT NEEDING (BARING) THE ENTROPY found naturally in: (1) of MITOCHONDRIA'S ORDER, CAUSED BY THEIRS ELONGATED NANO VOLUMES, permitting all life forms on the EARTH; (2) all other PHENOMENA of NATURAL or, MAN STIMULATED SPONTANEOUS RECTIFICATION of the MOLECULAR DISORDER INTO MOLECULAR ORDER of GASES and STEAM, allowing (practically) full conversion of the HEAT INTO WORK, at ZERO AIR POLLUTION, as opposing the PHENOMENA of the ENTROPY, relying on MOLECULAR DISORDER of the gases and steam, “justified” by the GEDANKEN, (not real, though, not feasible) thermodynamic CYCLE and ENGINE of Said CARNOT; thus, allowing only for minute efficiency of the heat to work conversion and a lot of industrial and car pollution, plus enormous exhaust of CO₂ in the atmosphere, menacing the world with GLOBAL WARMING; while the STARTLING ABILITY of BEZENTROPY for virtually FULL CONVERSION of the HEAT INTO WORK is not controlled by the classic thermodynamic, since the BEZENRTOPY is simply ‘THERMOMECHANICAL PROCESS’ RECTIFYING the HIDDEN, (INTERNAL) MECHANICAL KINETIC ENERGY OF THE MOLECULAR VIBRATION of the gases and STEAM—vibrating in all possible directions—RECTIFIED into LINEAR or, CIRCULAR KINETIC ENERGY and also into POTENTIAL ENERGY, all being mechanical and NOT HEAT ENERGIES; or, into BIO ELECTRICITY as in the MITOCHONDRIA; while in all cases of disordered vibration the vibrating energy of the molecules is CONCEALED into tiny volumes of NANO BUBBLES of diameter size equal to the MEAN FREE PATH of the molecules—and this occurs at any temperature and pressure—from where it becomes obvious that the energy losses required by ENTROPY can well be AVOIDED namely through said MECHANICAL RECTIFICATION producing directly once again mechanical energies: LINEAR KINETIC ENERGY, CIRCULAR KINETIC ENERGY and POTENTIAL ENERGY, all appearing due to the COLINEAR RECTIFIED VIBRATING MOLECULES, where such rectification DEFIES ENTROPY, by avoiding it, because the rectification simply CONVERTS A MECHANICAL FORM of ENERGY INTO ANOTHER FORM of MECHANICAL ENERGY and therefore, it has nothing to do with entropy and the methods of classic thermodynamics; hence, BEZENTROPY therefore, is NOT GEDANKEN, but is a real process of MECHANICAL RECTIFICATION, very similar and analoguous to the electrical rectification of the alternative current into direct current, which expunges the entropy, for it is also rectification of one non thermal form of energy into another such form; consequently, since science teaches that A MECHANICAL FORM of ENERGY is (practically) fully convertible into ANOTHER FORM OF MECHANICAL ENERGY (less the unavoidable losses from friction) then it becomes clear that the BEZENTROPIC RECTIFICATION OF THIS INTERNAL (HIDDEN, NON TANGIBLE) MECHANICAL ENERGY, of any GAS AND STEAM MOLECULE, INTO TANGIBLE JET OF COLINEAR MOLECULAR ENERGY MUST BE ALSO CONVERTIBLE IN FULL; there is one more explanation of this phenomenon related to the following new definition of heat: since the internal heat of the gases and the steam is a kind of kinetic energy, obtained from the eternal satellisation and the desatellisation of the PHOTONS around the electrons of the atoms (termed wrongly absorption and emission) since the photons, being particles without REST MASS, never stop to move and have KINETIC MASS mₖ stemming from the equation of the quantum relativity mₖ=hυ/c²; hence, because of that kinetic mass, the photons have strong mechanical impulse P=mₖ.C by which they are hitting, colliding and vibrating the molecules; thus, liberating free photons sensed as heath, where the photons perform said satellization and desatelisation around the electrons of the atomes are possessing mini electromagnetic field, which is also kind of mechanical exchange of energy, causing the concealed internal mechanical vibrating energy of the atoms (and because the PHOTONS behave both as heat and as mechanical particles, one may also say that the BEZENTROPIC RECTIFICATION PROCESS is also DIRECT FULL CONVERSION of the HEAT ENERGY into MECHANICLA ENERGY, defying the law of the entropy, through said rectification, ON ACCOUNT OF WHICH, the inventor rightfully short named his newly discovered law, ‘LAW OF THE BEZENTROPY’, after the Bulgarian word BEZ (meaning without) and the established scientific word ‘ENTROPY’, where said avoidance and defying the entropy (by the Bezentropy) is well averred and demonstrated also through the discovered by this inventors: PARADOX No 1, PARADOX No 2 and PARADOX No 3 of this patent' DISCLOSURE, where to the phenomena of the BEZENTROPY is added also the phenomenon of the VORTEX TUBE because, its separation of the gas molecules into HOT and COLD streams is actually adiabatic vortex rectification and separation of the molecules having HIGH KINETIC ENERGY OF ROTATION from the molecules of LOW KINETIC ENERGY OF ROTATION, where the ENTROPY is again AVOIDED, since the rectification is not energy conversion, the advantage from all above being: a possibility for constructing a series of BEZENTROPIC DEVISES, COMPRESSORS, ENGINES AND TURBINES, of SUPREME EFFICIENCIES and through said turbines and electrolysis obtained with inexpensive electricity from them, to obtain very inexpensive: ZERO POLLUTING HYDROGEN and other FUELS for the TRANSPORTATION, THE INDUSTRY and for HOME USES, obtainable by smart investing in this invention, which must PREVENT THE GLOBAL WARMING and bring back to the humanity the crystal clear air of the biblical time, using the followed plurality of bezentropic devices, compressors, turbines and engines:
(a) THE BLADELESS BEZENTROPIC GAS TURBINE comprising:
a cylindrical shaped bladeless, empty stator, designed to house the rotor of the BEZENTROPIC COMPRESSOR of the turbine, where instead of the classic ‘turbine blades’, the rotor has two wide sheet metal spirals welded in opposition around the shaft of the rotor, wound in opposing involute spirals coiled and inserted that way between the left and right metal disks forming with the shaft a reel at which disks the coils are also welded till the periphery of the disks, obtaining 2 opposing ‘spiral air ducts’ blowing air when the rotor is rotated for which both disks have near and around the shaft a series of suitable apertures and such apertures are provided also upon the left and the right covers of the stator, to allow the rotor to suck the necessary air for the desired air blowing;
two or more wide tubular air ducts—equal to the number of the used combustion chambers—welded upon the special apertures upon cylindrical stator's periphery and the others ends of said tubular air ducts are connected with suitable nozzles of Laval, them self (the nozzles) being then connected with the chambers of the combustion, of the working turbine, where the task of the nozzles is to increase the DYNAMIC PRESSURE of the blowing, thus, working as check valves of the combustion chambers,
another pair of ROTOR AND STATOR making the working part of the TURBINE (in general of same construction as that of the bezentropic compressor) having similar rotor with similar spiral canals, housed inside a similar bladeless cylindricaly shaped stator, at which periphery are fixed—the more beneficial—TRIPLE ACCELERATING FLAT NOZZLES of the inventor, as described in the specification, each one connected to each chamber of combustion, where the diameter size of the rotor housed in the stator is smaller than that of compressor's rotor while its cylindrical length is larger to create a volume than these of the compressor;
a series of aperture upon the left and the right covers of the turbine's working rotor and stator, placed around the shaft, from where the turbine. exhausts its combusted and used gases;
a number of fuel delivery systems—of classic construction—delivering fuel to each chamber of combustion;
spark plugs for each chamber of combustion and a common ignition system, plus one STARTING ENGINE (needed for every gas turbine, to generate initial air flow to the chambers of combustion till the ignition of the air and gas combustion there) allowing then, to deliver the needed air flow on its own, rotating alone its compressor, thus, starting normal work;
(b) THE TOROIDAL STARTING ENGINE OF THE Bz. GAS TURBINE of the plurality, and for other purposes, obsoleting all classic piston engines representing another ENGINE defying the ENTROPY leading again to higher efficiency and for that reason is again bezentropic engine comprising:
a toroidal working volume of rectangular cross section inside of which is housed a rotor, on which periphery is fastened a single rotating piston, shaped like a tooth, but, having its left and right profiles following epy cycloid like curves,
a shaft having suitable bearings allowing to rotate the rotor,
a cylindrical rotating chamber of combustion inserted in own cylindrical housing fixed at the periphery of the toroidal working volume and allowing the rotating chamber of combustion to contact the periphery of the rotor, synchronized with the rotor in ratio of 1:1, where upon this chamber of a combustion is cut out an empty space to conform with the profiles of the piston, so to allow smooth contact with the rotating piston of the rotor,
a rotating cylindrically shaped, ‘volume separator’, analogous to the combustion chamber also synchronized with the piston in ratio of 1:1, used to subdivide the working volume in ratio of 1:3 to 1:4, where the smaller volume of the subdivision is reserved to SUCKING and COMPRESSION of the air and fuel mixture and the larger to the working EXPANSION and EXHAUST processes of the engine, where the reason for said subdivision is to create a (new) ‘bezentropic thermodynamic cycle’ of full expansion of the working body, accompanied by useable kinetic energy, cogenerated by eliminating the classic ‘low’ and ‘high’ “death points” of the reciprocating:piston engines for they are main promoters of MOLECULAR DISORDER BARING the more beneficial KINETIC ENERGY there and this way inviting the ENTROPY and the low efficiency of the classic engines,
a suitable stator with left and right covers to house: the rotor, the combustion chamber and the separator of this toroidal kind of bezentropic engine,
a rotating spar plug fixed at the shaft of the rotating camera,
a carburetor or, fuel injection pump, plus ignition system, igniting the engine (like a car) to perform its ‘bezentripic heat cycle’, characterized—differently from the classic engines—that it accepts and perform ‘direct integration for conversion to work the NATURAL TOTAL DIFFERENTIAL OF THE HEATH NAMED ‘ENTALPY’ converting it fully to ‘KINETIC ENERGY’ and WORK, which is not possible with the classic reciprocating engine and turbines, for they are accepting only PARTIAL DIFFERENTIALS OF THE HEAT which invites the ENTROPY and energy losses; naturally, the new engine may comprise more than one toroidal stator and rotor;
so far, the toroidal bezentropic engine is the BEST STARTING ENGINE for the BEZENTROPIC GAS TURBINE and being connected to turbine's ‘bezentropic rotary compressor’ upon ignition starts rotating the turbo compressor thus blows air and fuel in turbine's combustion chambers; CAUSING STRONG JETS blowing turbine's rotor and starts to work on its own, disconnecting the starting engine;
(c) THE UNIVERSAL BEZENTROPIC STEAM TURBINE of the plurality, working by steam generator selected among the plurality: (1) of the classic seam generators, (2) of the nuclear steam generators and (3) of the FREON STEAM GENERATORS; where the most advantageous are the freon steam generators, since all ecological permitted freons have very low boiling temperatures—in the order of −50° C.—thus, providing unusual opportunity to derive most of the needed heat FROM THE DIFFUSED SUN ENERGY contained in the THE ATMOSPHERIC AIR, plus allowing to obtain a pressure of tens of atmosphere only by heating the freon at +50° C. to no more than +100° C., such turbine containing:
a bezentropic bladeless stator, housing a bezentropic rotor, usually having 2 to 3 working spiral canals as above described,
a steam generator selected from the above specified plurality of steam generators
the more suitable FLAT NOZZLE, as described in the specification and above, connecting the turbine with the steam ducts—of its steam generator—on account of which the turbine starts to work when firing the steam generator to produce a steam pressure in the order of 20 to 30 atmospheres,
(d) THE FREONFALL BEZENTROPIC HYDRAULIC TURBINE of the plurality, converting the ‘latent heat of vaporization’ of the freon steam first into potential energy—by tubular elevation of that steam—until all latent heat of the vaporization is converted to potential energy by the elevation and because of that starts condensation creating FREON RAIN, which is collected “in situ” by a receiving box—preferably into a RECEIVING COOLER—starting from there a FREONFALL going down to the ground through a tube to “feed” with its ‘kinetic energy’ the installed on the ground FREON HYDRAULIC BEZENTROPIC TURBINE, made of SPIRAL construction similar to the above described ‘universal steam turbine’ but, naturally of dimensions and resistance. suitable for hydraulic turbine; after which, the exhausted liquid freon is directed back to the FREON HEATER, by a pump, to start a new round of freon evaporation, elevation, condensation and rain, where in summer time, the freon CAN BE HEATED—days and nights—ONLY BY DIFFUSED SUN ENERGY heating the atmospheric air, sucked from there by a bezentropic compressor, then blown into a VORTEX TUBE to further increase its temperature and then blown in the serpentine of the freon heater, while the COLD AIR part of the vortex tube is blown in said COOLER to fasten the formation of the FREONFALL Where the freon and its steam must be circulated INTO HERMETICALLY CLOSED CIRCUIT where the NEEDED tubular elevation of the freon steam should be in the order of 100 to 200 meters, and the relevant parts of this installation are:
a freon heater using a fire place, possessing also a serpentine for air heating providing simultaneously heat taken from the atmospheric air—mainly during summer time—for which the air molecules are first separated into hot and cold flows by a vortex tube; then, its hot flow is blown in the freon boiler to generate the freon steam;
a tubular elevation of the freon steam of up to 100 to 200 meters, creating this way POTENTIAL ENERGY, generated from steam's latent heat of the vaporization, causing its condensation into FREON RAIN discharged in a cooler where the freon rain is further accelerated by the by the cool air coming from the COLD END of the VORTEX TUBE and then, said potential energy is spontaneously converted to KINETIC ENERGY through the tubular FREONFALL flowing down to the hydraulic turbine causing there enormous rotating force and
a freon type bezentropic hydraulic turbine—installed on the ground—rotated by the powerful kinetic energy of said FREONFALL,
a BEZENTROPIC COMPRESSOR connected with said VORTEX TUBE rotated by the turbine, needed to suck ATMOSPHERIC AIR and deliver it to the VORTEX TUBE for separating air's molecules into high and low velocities through rotating them in 2 coaxial flows, flowing in opposing directions, where the inner flow deliver its energy to the outward flow, thus creating HOT and COLD AIR FLOWS,
a pump pumping the exhausted liquid freon from the turbine to the FREON HEATHER to allow continuous evaporation of the freon in order to support continuous work of the turbine,
(e) THE IMPROVEMENT OF THE OLD VORTEX TUBE of George Ranque (public domain for more than half a century) made by replacing its ‘vortex camera’ with a more efficient CAMERA consisting of a large FLAT SPIRAL CANAL blowing in that camera—for more efficiency-compressed air from one ELLIPTIC COMPRESSOR through a ‘nozzle of Laval where this nozzle increases the velocity of the air flow inputted in the vortex tube, resulting in millions of vortex RPM inside that tube, causing at its hot end to generate air of very high temperature and at its cold end air very low temperature as above described with particulars,
(f) THE TOROIDAL CRYOGENIC (FREON) ENGINE of the plurality, comprising:
a double toroidal bezentropic engine one of them working by freon steam and the other by compressed air, joined by an elliptic compressor, all of them sharing one and same shaft,
the above described improved VORTEX TUBE working by compressed atmospheric air of 4 to 8 atmospheres, or more, delivered to the tube by one elliptic compressor via the improved nozzle of Laval, where the HOT END of the vortex tube is delivering air at 100° C. to 130° C. in the serpentine of the heater to generate the freon steam; then, same air go in the above stated air driven toroidal engine to perform work, while the cold end of the same vortex tube is used first to cool and condense some (eventually left). uncondensed freon steam, coming from the toroidal freon steam engine, after which that cold air is directed also to said air driven engine—to perform additional work—since the cold air has also significant amount of KINETIC ENERGY,
a freon boiler needed to generate the freon steam for driving said toroidal engine heated mainly by atmospheric air advance via said VORTEX TUBE but, having also a gas heater used mainly to start the combined engine and (when needed) during cold winter time; consequently, this is generally BEZENTROPIC SUN ENGINE, WORKING DAYS AND NIGHTS CAPTURING SUN ENERGY, INDIRECTLY, FROM THE ATMOSPHERIC AIR, without involving the expensive and enormous number of MIRRORS, PHOTOCELLS and LARGE PARCELS of LAND to install the expensive power plants using direct SUN ENERGY,
(g) BEZENTROPIC WIND TURBINE
which essentially resembles to the bezentropic steam turbines for has same bladeless cylindrical stator, housing same reel like rotor. on which are winded 2 or more spiral metal sheets forming 2 or more spiral canals, where this time is blown not steam but wind, captured by an—open to the Wind—extra large sac made from tissue, elevated on 30 to 100 meters at the top of a pole from where the wind is directed down and blown in the placed on the ground turbine through tube made of tissue and said turbine when connected with an electric generator becomes a wind power plant,
(h) BEZENTROPIC VORTEX PROPULSION AND ITS IONIC FUEL
This VORTEX PROPULSION performed through another radical modification of the classic VORTEX TUBE is potentially more beneficial than the popular JET. PROPULSION SYSTEM comprising:
a toroidal bezentropic engine driving an elliptic air compressor, blowing pressured air into a nozzle of Laval having the task to convert the static pressure of the compressor into strong DYNAMIC PRESSURE, blown in the spiral still camera of the vortex tube as above described where said dynamic pressure is blown into said
radically modified vortex tube of wide divergent conical shape welded at the center of the spiral camera, not having the cold and hot ends of the classic vortex tube, since the purpose of the modification is not generating cold and hot air, but, to cause extra speedy rotation of the ionic fuel passing through that divergent tube and in the mean time to suck and rotate additional air coming from its aperture at the opposing end of the divergent tube,
a cracking camera to crack ammonia by electric arc or by temperature of over 600° C., generating that way IONIC FUEL consisting of ionized atomic hydrogen stable for about 30 seconds plus N₂, needed both to fuel the toroidal bezentripic engine and push the divergent (conical) tube of the vortex propulsion,
an optional rotating magnetic field around the very beginning of the conical tube. to further accelerate the vortex spinning of the ionic fuel; where,
the vortex propulsion pushing upon. the divergent conical nozzle is providing more advantageous CIRCULAR KINETIC ENERGY of several million revolutions per second —developed there by the ionic fuel, until is fully exhausted—inside the tube attained by the centrifugal pressure, said spinning and the rotating magnetic field, thus, pushing the aircraft vehicle in more efficient manner, because in the traditional THE JET PROPULSION, only a small part of linear kinetic energy actually makes the push the rest being exhausted in the atmosphere without benefit; thus, causing energy loss and pollution while the IONIC FUEL is zero polluting because, upon burning produces only N₂ and water steam both of which are normal constituent of the air, where:
the vortex propulsion start with the ignition of the electric arc in the cracking chamber producing from the NH₃ said ionic fuel—first starting the TOROIDAL BEZENTROPIC ENGINE—which rotate the ELLIPTIC COMPRESSOR after which as soon as the compressor starts to blow compressed air in Laval's nozzle in the spiral camera of said modified vortex tube, the fuel passing through the nozzle ignites and the system starts its normal VORTEX PROPULSION, where as another ZERO POLLUTING FUEL should be used the inexpensive hydrogen derived from through the inexpensive electricity of the next (i) plurality titled:
(i) PLURALITY OF BEZENTROPIC POWER PLANTS
whose main purpose is to produce by them sufficiently inexpensive electricity and use it to produce inexpensive hydrogen from water through electrolysis; thus to attain the main goal of this invention, which is ZERO POLLUTION WORLDWIDE and ARRESTING THE GLOBAL WARMING, which is well possible with adequate investments in this invention and if supported also worldwide, by responsible governments policies supporting the claimed plurality of the unique BEZENTROPIC POWER PLANTS—designed to help anyone—consisting of any combination among:
the plurality of the disclosed BEZENTROPIC TURBINES and ENGINES and especially these using FREON as working body in combination with the elliptic compressor and the improved vortex tube as best way fore extraction of inexpensive indirect SUN ENERGY, days and nights, from the atmospheric air, using this free heat energy to generate FREON STEAM—in closed circuit—to power the FREON VARIANT of the BEZENTROPIC TURBINE, rejecting for that purpose the expensive and burdensome mirrors, photo sells and extensive land also for all other disclosed variants of the BEZENTROPIC TURBINES and ENGINES which when combined with a suitable ELECTRIC GENERATOR results in POWER PLANTS producing remarkably inexpensive electricity and when it is produced from natural gas (methane), other hydrocarbon or, coal the power plant must be erected near a see shore or, next to a big river to pump there the by-produced CARBON DIOXIDE which will combine there with the CALCIUM, MAGNESIUM and other alkali earth IONS, forming with them the neutral LIMESTONE, DOLOMIT and other carbonate rocks which are, actually, the water cleaning sediments of Mother Nature,
(j) THE ZERO POLLUTING PROCESSES FOR ENERGY AND ECO FUELS:
the best ZERO POLLUTING ENERGY AND FUELS in the world are the SUN ENERGY and the HYDROGEN; however, the sun energy is extremely diffused, costly when collected through photo sells and not working during nights and cloudy days. On the other hand, free hydrogen is not existing in our planet and must be derived from its compounds like the water through the expensive electricity, the expensive hydrocarbons, or from the expensive synthetic quality coal and synthesis. Free electricity is also not available in the world and must be derived from the expensive primary fuels via the power plants. Moreover,
the electrolysis of the water, to obtain affordable hydrogen fuel, needs to be at least 2 times less expensive electricity to be acceptable by the public. On account of this problem, presently only 4% to 5% of hydrogen is derived worldwide via electrolysis notwithstanding that, chemically, the electrolysis is efficient and elegant method, by-producing also the valuable oxygen. Apart these problems, the hydrogen derived today from natural gas and from coal (via the intermediary synthesis gas) is polluting, waistfull and expensive technology, by-producing a lot of pollutants, CO₂ and a lot of ‘synthetic water’ out of the precious hydrogen of the synthesis gas. Hence, to solve these problems the inventor found that the best way to do that is better to abandon THE DIRECT SUN LIGHT FOR ELECTRICITY switch to the INDIRECT SUN ENERGY extracting it from the atmospheric air via the plurality of the bezentropic freon power plants and the freon VORTEX HEAT PUMP, of. this invention, capable to heat also the disclosed new REDOX PROCESS for deriving hydrogen and oxygen out of the water.
Moreover it should be taken into consideration also that the hydrogen is a very dangerous gas, since when is blended with air by volumes of 4% to 84% hydrogen that makes very dangerously explosive mixture, difficult to be handled and piped; hence, to dream replacing the methane, the other hydrocarbons or, the coal by hydrogen, one must first solve the following problems:
(1) to convert the H₂ to quiet gas. fuel not containing any pollutants,
(2) to produce it from electrolysis or, through sun energy in order to make. its manufacturing also ZERO POLLUTING,
(3) to find out a new and abundant source of primary fuel for powering the bezentropic power plants, which must be less expensive than the natural methane gas and lasting (practically) forever in order to have 2 to 3 times less expensive electricity, thus, allowing to be used for electrolysis of the water, for affordable hydrogen and by-produced oxygen,
(4) to find a way of getting rid from the CO₂ (by-produced during the combustion of said primary fuel) not exhausting it in the atmosphere; all of them very difficult problems not satisfactorily solved to present, but, well solved by this invention as follows:
the first problem was solved following the example of Mother Nature, who quieted the even more dangerous OXYGEN, by blending 1 part oxygen with 4 parts NITROGEN and that way obtaining the quiet air; hence, copying Mother Nature the inventor established that when inexpensive Nitrogen—derived as by-product from the combustion of the bezentripic power plants—is blended by 10% to 40% inexpensive hydrogen—derived from the inexpensive electricity of the bezentropic power plants—the result is excellent inexpensive AND QUIETED HYDROGEN FUEL BLEND, suitable for delivery by gas pipe lines to the industry and for the homes,
the second problem was solved by a plurality of 2 solutions, the first of which is the electrolysis of the water with said inexpensive electricity of this invention and the second by a new, low temperature REDOX PROCESS of the inventor involving: 2MnO₂+4NaOH+talc evolving 4H₂ when heated at about 350° C. in the absence of air and then, restoring the initial ingredient when submit the obtained compound to warm hydrolysis when in the mean time is liberate oxygen, where said heating is performed either by direct sun energy or, preferably by indirect (diffused) sun energy extracted from the air by the above described IMPROVED VORTEX HEAT PUMP, in cold weather USING ALSO THE ELLIPTIC COMPRESSOR of this inventor and the exhausted from the power plant combusted gases to obtain the above temperature of 350° C. or, higher, (#) the best solution of the third problem represents the solid METHANE HYDRATES found at the bottom of BLACK SEA and in many other sees and oceans in the world which will last, practically for ever, since only in. the Black Sea the GEOLOGISTS and GEOPHYSICITS (the inventor is one of them) believes that would last for several tens of thousand years since they are actually renewable source of energy, due to the many large natural springs of METHANE compounded continuously with the see water into solid METHANE HYDRATES—a PHENOMENON occurring at pressure. of more than 20 atmospheres and temperature below of 10° C., the other eternal source of energy being the SUN ENERGY which becomes inexpensive, when extracted from the air, via said bezentropic heat pump which that way could becomes even tens of times less expensive than the panels of the photo sells,
the radical solution of the fourth problem—needing to get rid of the CO₂— is to erect from now on every thermal power plant—be it classic or, bezentropic—near a big river (like the DANUB river for example) or, near a see shore, and dump there the CO₂, which will not pollute, but, will actually clean these waters for they are full of alkali erth iones which easily combine with that Carbon Dioxide, yielding the known NEUTRAL CARBONATE ROCKS in the world (all made namely that way for million years in the pas geological times) then, let's follow MOTHER NATURE'S success for simultaneous cleaning both the air, the waters and arrest the menacing GLOBAL WARMING, before the end of this century and
another radical way to get reed from the CO₂ is to use as FUEL for the beentropic—as well as for the classic thermal power plants around the BLACK SEA—the poisonous H₂S gas—found dissolved in the water there at depth of more than 150 meters—using that gas as fuel for obtaining from it inexpensive electricity and hydrogen fuel by the following absolutely CLEAN steps of the following technology:
step (1) pumping out said saturated on H₂S Black Sea water on the nearest see shore—where a power plant is erected and dumping it into one hermetic metal reservoirs;
step (2) using a special underwater spark plug is initiated a series of underwatted electric explosions which liberates that gas (hydrogen sulfide) from the water and is then piped to the FIRE PLACE of power plant's steam turbine;
step (3) igniting and burning the hydrogen sulfide in FLUIDISED BED of limestone pellets (CaCO₃) or, in calcium hydroxide Ca(OH)₂ which converts the sulfur to the valuable neutral gypsum while the heat of the combustion generates the necessary steam of the bezentropic power plant;
step (4) the inexpensive electricity of that plant is then used to produce hydrogen fuel via electrolysis of the water,
(k) THE BEZENTROPIC METHOD FOR PROSPECTING AND MINING THE METHANE HYDRATES, AS A NEW SOURCE ETERNAL ENERGY
in the last 15 years, or so, expeditions of geophysicists and geologists (mainly from RUSSIA, UKRAINE, GERMANY, USA, JAPAN and BULGARIA) started to prospect the rocky GAS HYDRATES, at the bottom of the sees and oceans, paying attention mainly to the valuable METHANE HYDRATES, not yet published in the university's text books (and most of them kept as professional secrets since non of them has yet reliable method of mining them) but all researchers consider the methane hydrate, rightfully, as the FUELS OF THE NEAR FUTURE, since to present there is no reliable DEEP SEE MINING TECHNOLOGY for METHANE HYDRATES; consequently, very few people in the world heard or, know that the ROCKY METHANE HYDRATES are the most valuable, abundant, potentially inexpensive and alternative fuel energy for the entire world—should its deep see mining problem is solved—moreover, to present only the specialist know that the methane hydrate— are unstable compounds which could exists only in deep sees bottoms for they need pressure of over 20 atmosphere and temperature of below 10° C. to exists, for otherway they disintegrate them self into water and methane gas; such gas however makes no sense without a method for mining them; hence, knowing much more details about them, this inventor who is also a retired geophysicist, studied that hard problem and is now claming the following viable solution, helpful both as less expensive geophysical prospecting and mining of the methane hydrates, claiming:
a new method for less expensive geophysical prospecting and mining of METHANE HYDRATES, deriving from them the best fuel for the claimed bezentropic power plants and engines, based essentially on the above disclosed inexpensive electricity from the bezentropic power plants where at least one of them is mounted on a floating see platform where its electricity is used to create series of underwater electric explosions—trough electric short circuits—on the see bottom where the gas hydrates are found and—that way—are decomposed to methane gas and water, accelerating that process also by the exhausted hot cooling water cooling the power plant, pumped down to the see bottom through a suitable hose ending with a wide bell inside of which are performed the electrical explosions—doing the fundamental job of the methane decomposition, accelerated during summer time also by pumping down—inside the same. underwater BELL—hot surface see water, the bell being connected with a second hose helping to evacuate and transport the so obtained METHANE up to the see platform, where small part of it is used to power said ‘on board power plant’, and the rest is liquified and sent to the nearest see shore for commercial, industrial, electricity and hydrogen fuel. deriving and other purposes, while the CO₂-obtained from burning the methane in said power plants is pumped back in the see where is. neutralized and converted to neutral alkali-earth carbonates; while the same method but, purposely minimized and joined by one underwater T.V. CAMERA and by one GSP (Geostatic Positioning System) CAMERA, can be efficiently used also for less expensive visual geophysical prospecting for methane hydrates, replacing the presently used expensive geophysical seismic method of prospections of methane hydrates,

2. The bezentropic process of processes of claim 1 limited to its (a) BLADELESS BEZENTROPIC GAS TURBINE,

3. The bezentropic process of processes of claim 1, limited to its (b) TOROIDAL TYPE BEZENTROPIC ENGINE for starting the bezentropic gas turbine and for other applications,

4. The bezentropic process of processes of claim 1, limited to its (c) UNIVERSAL BEZENTROPIC STEAM TURBINE, capable to work by classic steam generator, by nuclear steam generator and by closed circuit freon steam generator of that clamed plurality,

5. The bezentropic process of processes of claim 1, limited to its (d) FREONFALL BEZENTROPIC HYDRAULIC TURBINE, converting the latent heat of the vaporization of the freon—through elevation—first to potential energy, then to freon rain and after that to linear kinetic energy of the so obtained freonfall, directed to rotate the bezentropic “hydraulic” turbine by that freonfall,

6. The bezentropic process of processes of claim 1, limited to (e) THE IMPROVED OLD VORTEX TUBE, defined as another bezentropic device,

7. The bezentropic process of processes of claim 1, limited to its bezentropic
(f) CRYOGENIC TOROIDAL ENGINE, using the freon as its working body,

8. The bezentropic process of processes of claim 1, limited to its (g) BEZENTROPIC WIND TURBINE,

9. The bezentropic process of. processes of claim 1, limited to its (h) BEZENTROPIC WIND TURBINE, combined. with suitable electric generator to become a WIND POWER PLANT,

10. The bezentropic process of processes of claim 1, limited to its (i) PLURALITY OF BEZENTROPIC TURBINES and ENGINES, combined with suitable electric generators, to become BEZENTROPIC POWER PLANTS

11. The process of processes of claim 1, limited to its (j) ZERO POLLUTING PROCESSES FOR INEXPENSIVE BEZENTROPIC ELECTRICITY FROM METHANE AND HYDROGEN SULFIDE; THEN, DERIVING FROM THAT ELECTRICITY INEXPENSIVE ECO FUELS FOR CARS, INDUSTRIAL AND HOME USES,

12. The process of processes of claim 1, limited to its (k) BEZENTROPIC METHOD FOR PROSPECTING AND MINING OF METHANE HYDRATES, AS A NEW SOURCE OF (PRACTICALLY) ETERNAL, AS WELL AS RENEWABLE, INEXPENSIVE ENERGY FOR RADICAL SOLUTION OF THE AIR POLLUTING AND THE GLOBAL WARMING PROBLEMS.
